(19) United States
(12) Patent Application Publication
(10) Pub. No.: US 2025/0179316 A1
(43) Pub. Date: Jun. 5, 2025

(54) PHOTORESIN AND METHOD FOR SURFACE PATTERNING OF A SOLID OBJECT

(71) Applicant: National Research Council of Canada, Ottawa (CA)

(72) Inventors: Xiangyang LIU, Ottawa (CA); Antony ORTH, Victoria (CA); Nicolas MILLIKEN, Manotick (CA); Thomas LACELLE, Ottawa (CA); Chantal PAQUET, Ottawa (CA); Arnold Jason KELL, Ottawa (CA); Daniel WEBBER, Kanata (CA)

(21) Appl. No.: 19/050,918

(22) Filed: Feb. 11, 2025

Related U.S. Application Data
(63) Continuation-in-part of application No. PCT/CA2023/051239, filed on Sep. 19, 2023.
Application No. PCT/CA2023/051239 is a continuation of application No. 18/102,936, filed on Jan. 30, 2023.
(60) Provisional application No. 63/408,239, filed on Sep. 20, 2022.
(60) Provisional application No. 63/410,384, filed on Sep. 27, 2022.
(60) Provisional application No. 63/409,846, filed on Sep. 26, 2022.

(30) Foreign Application Priority Data
Jan. 30, 2023 (CA) 3,188,013

(51) Int. Cl. C09D 11/101; B33Y 10/00; B33Y 50/02; B33Y 70/10; B33Y 80/00; C08L 33/08; C09D 4/06

(52) U.S. Cl. CPC C09D 11/101; B33Y 10/00; B33Y 50/02; B33Y 70/10; B33Y 80/00; C08L 33/08; C09D 4/06

(57) ABSTRACT

A photoresin composition for photopatterning in an oxygen-containing environment has a viscosity of about 300 cP or higher and contains: a reactive monomer with no hydrogen atoms having a bond-dissociation energy of less than about 410 kJ/mol, the hydrogen atoms; a non-amine reducing agent; and, a Norrish Type II photo-initiator. A volumetric additive manufacturing (VAM) process involves: immersing a solid base object in a liquid photoresin composition containing a photo-initiator and a multifunctional material; removing the solid base object with a film coating thereon from the liquid photoresin composition; and, selectively irradiating the composition at the surface of the object with patterned light to initiate covalent grafting or adhesion of the multifunctional material to the surface of the object to pattern only a portion of the surface of the object, where the portion of the surface of the object corresponds to the selectively irradiated surface of the object.

### CROSS-REFERENCE TO RELATED APPLICATIONS

This application is a continuation-in-part of PCT/CA2023/051239 filed Sep. 19, 2023, which claims the benefit of U.S. provisional patent applications 63/408,239 filed Sep. 20, 2022, 63/409,846 filed Sep. 26, 2022 and 63/410,384 filed Sep. 27, 2022, and which also claims priority to Canadian application 3,188,013 filed Jan. 30, 2023 and U.S. application Ser. No. 18/102,936 filed Jan. 30, 2023, the entire contents of all of which are herein incorporated by reference.

### FIELD

This application relates to photoresin compositions and methods for surface patterning of a solid object, for example by volumetric additive manufacturing (VAM).

### BACKGROUND

Polymer objects often require their surfaces to be chemically modified to make the object functional. The surface modifications can be uniform or have a specific pattern. Examples include modifying a surface to change its wetting properties, alter its stiffness or hardness, or enable further chemistry that allows new materials, such as a metal, ceramic, or a different polymer, to be attached to the surface, and the like. This type of surface modification is used in microfluidic devices, sensors (to add a sensing element to a substrate), light-weight electronics, bio-scaffolds, encryption, and others. When the object whose surface needs to be modified has a complex geometry, it is often difficult or impossible to modify the surface as the shape and geometry make it difficult to access the surface. Therefore, there exists a need for a method and materials that can allow for a new material to be grafted to a polymer object with complex shapes.

Current approaches have been developed to impart spatial functionality to surfaces but are limited to two dimensional surfaces or to conformal surfaces with low complexity. Examples include photolithography, chemical vapor deposition, layer-by-layer deposition, polymer grafting, and others. Some studies have fabricated more complex 3D surfaced patterned objects with the use of two photon polymerization or direct laser writing; however, these techniques are expensive, slow (print time can take hours), and restricted to small scale patterning (micro- or nano-features).

Tomographic 3D printing, also known as volumetric additive manufacturing (VAM), can be used to 3D print overtop a 3D object. Tomographic 3D printing is an emerging 3D printing technology that uses photoresins to fabricate complex 3D objects at once while reducing or eliminating the need for support structures. In this technique, light images, obtained through the reverse of computed tomography (CT), are projected towards a rotating container filled with photoresins. Only once the photoresin locally absorbs a light dose exceeding a ‘gelation threshold’ does the photoresin solidify to form the desired 3D object.

Tomographic 3D printing can also be used to introduce a second polymer structure to an existing 3D object. In overprinting, a first object is submerged in the photoresin before printing, and the tomographic printer projects patterned light that initiates polymerization around the first object resulting in a polymer object being printed onto the existing first object of similar or different material. Overprinting prints overtop of existing objects and is limited to printing singular large features, making it difficult to achieve uniform and highly controlled surface patterns required to fabricate many devices. Overprinting also does not introduce the second polymer through a covalent bond, and therefore, would not be effective at surface patterning thin films that are also required to modify materials for many devices and sensing applications. Overprinting does not enable the fabrication of multiple material properties and interfacial reactions in desired areas on the surface of objects (spatial patterning of functional materials).

There remains a need for compositions and processes for selectively patterning a surface of a solid object with a material, with the material covalently bonded to the surface of the object.

### SUMMARY

A volumetric additive manufacturing (VAM) process for producing a solid object having a surface layer of a multifunctional material patterned thereon comprises: contacting a surface of a solid base object with a liquid composition comprising a photo-initiator and a multifunctional material covalently graftable to the surface of the solid base object; and, selectively irradiating the composition at the surface of the solid base object with patterned light, the irradiating being tomographic, to initiate covalent grafting of the multifunctional material to the surface of the solid base object to pattern only a portion of the surface of the solid base object with a layer of the multifunctional material grafted thereon, where the portion of the surface of the solid base object corresponds to the selectively irradiated surface of the solid base object.

A photoresin composition for photopatterning in an oxygen-containing environment has a viscosity of about 300 cP or higher and comprises: a reactive monomer with no hydrogen atoms having a bond-dissociation energy of less than about 410 kJ/mol; a non-amine reducing agent; and, a Norrish Type II photo-initiator.

A volumetric additive manufacturing (VAM) process for producing a solid object having a surface layer of a multifunctional material patterned on the solid object comprises: immersing a solid base object in a liquid photoresin composition comprising a photo-initiator and a multifunctional material; removing the solid base object from the liquid photoresin composition thereby providing the solid base object with a film coating of the liquid photoresin composition; and, selectively irradiating the composition at the surface of the solid base object with patterned light to initiate covalent grafting or adhesion of the multifunctional material to the surface of the solid base object to pattern only a portion of the surface of the solid base object with a layer of the multifunctional material grafted or adhered thereon, where the portion of the surface of the solid base object corresponds to the selectively irradiated surface of the solid base object.

The process uses tomographic 3D printing to spatially control overprinting and covalent bonding of multifunctional materials to the surface of an existing solid base object to provide the solid base object with new surface properties. Light projected from a tomographic printer initiates grafting of the multifunctional material to an existing surface of a solid base object, and in some embodiments, initiates a photo-reaction (e.g., polymerization, substitution reaction, addition reaction or the like) of the multifunctional material at the surface of the solid base object. The process may be done by a one-step process where the solid base object is immersed in a mixture of a photo-initiator and a multifunctional material. The process may be done in a two-step process where the solid base object is first immersed in a solution of photo-initiator and a solvent for a designated period of time, and subsequently rinsed and possibly dried, then followed by immersion of the photo-initiator-coated solid base object in a mixture of photo-initiator and multifunctional material. The two-step process improves grafting efficiency because more photo-initiator molecules are available on the surface to initiate grafting. Grafting efficiency is a ratio of the weight of the grafted polymer to the weight of all polymer formed. If the grafting efficiency is 100%, then all the polymer chains are covalently linked to the surface. In a variation of the process, particularly useful when oxygen can interfere with grafting of the multifunctional material to the surface of the solid base object, the solid base object may be immersed in the liquid composition and then removed and placed in an inert environment for irradiation. In another variation of the process, a primer layer may be applied to the surface of the solid base object and the solid base object with the primer layer immersed in a mixture of a photo-initiator and a multifunctional material.

Following any of the above approaches, patterned light is projected using a tomographic printer; however, the light dose is only applied to the surface of the print, for example with a thickness of about 0.5 mm to about 1 mm to ensure overlap between the solid base object and printed surface pattern, i.e., an interfacial region between the base object and the liquid composition. The projected light activates the illuminated regions on the surface of the solid base object and the liquid composition and initiates grafting of the multifunctional material to the surface in the regions being illuminated.

Photo-initiated grafting can be achieved through many common reaction mechanisms. Some examples are free radical polymerization, anionic polymerization, reversible addition-fragmentation chain-transfer polymerization, cationic polymerization, atom-transfer radical polymerization, living polymerization, click chemistry, and the like. Depending on the surface properties desired, the appropriate grafting method and multifunctional material can be chosen accordingly. In addition, based on the multifunctional material grafted to the surface of the base object, a subsequent step can be applied to react the coating of multifunctional material with other species or deposit other materials, on to the patterned surface to further change the properties of the surface of the solid base object.

The process enables printing of functional materials in defined locations on a three-dimensional (3D) solid base object as opposed to providing uniform chemistry throughout the surface of the 3D object. Further, the process results in covalent grafting of the multifunctional material to the solid base object in the defined locations, which provides a more robust and securely coated layer of the multifunctional material in those locations. The process benefits from the versatility of the chemistries that can be applied to the 3D grafting method, such as photo-radical polymerization, photo-click chemistry, photo-cationic polymerization and photo-reversible addition-fragmentation chain-transfer polymerization and therefore enables a broad set of materials to be patterned on the surfaces of the solid base object. It is therefore possible to produce heterogeneous functionality on the surface of objects resulting in surface patterns with a variety of different properties and materials. Surface patterning using tomographic printing is fast (less than about 1 min), which is significantly faster than lithography (requiring hours), lithography using rastering lasers or two photon polymerization techniques. Tomographic printing also uses low-cost components (rotation stage and projector). Further, unlike most surface patterning methods currently used, the present process can pattern materials on objects having much more complex geometries. The process makes it easier and cheaper to produce complex multi-material surfaces.

Applications of the process described herein are broad as the process advances the deployment, use, and abilities of a new additive manufacturing technique. The process enables fabrication of 3D printed polymer-based parts with unmatched design freedom. For example, surface patterning by the process can be used to produce areas with defined properties, such as anti-fogging, anti-microbial, hydrophobic/hydrophilic, wetting, electrical conduction, etc. Other applications include surface patterning of shape memory polymers (4D printing, features respond to environmental stimuli, such as temperature, voltage, humidity, pressure, etc.), encrypted designs visible under certain wavelengths of light, protective coatings with improved energy absorbing properties, bio-scaffolds to promote cell proliferation and growth in certain desired areas, light-weight complex electronic components, diagnostic devices with spatial reaction to certain compounds, specialty optics, and lenses and antennas for RF telecommunications.

In some embodiments, the step of selectively irradiating comprises irradiating with the patterned light that is calculated and projected using tomographic imaging. In some embodiments, the step of selectively irradiating is accomplished with 2D light patterns calculated using computed tomographic methods and/or according to the geometric intersection of the projected beam and the solid to be patterned.

In some embodiments, the solid base object is immersed in the liquid composition during irradiation. In some embodiments, the solid base object is immersed in the liquid composition and then removed and placed in an inert environment for irradiation. In some embodiments, prior to contacting the surface of the solid base object with the liquid composition, the surface is contacted with a solution of a same or different photo-initiator to provide a film of the same or different photo-initiator on the surface of the solid base object.

In some embodiments, the solid base object contains functional moieties that are graftable to the multifunctional material. In some embodiments, the functional moieties comprise acrylates, methacrylates, thiols, allyls, acrylamides, methacrylamides, epoxides, azides or any mixture thereof.

In some embodiments, the surface of the solid base object comprises a layer of primer material to which the multifunctional material is covalently graftable, In some embodiments, the primer material comprises 3-(trimethoxysilyl) propyl methacrylate (TMSPMA), allyltrimethoxysilane, (3-glycidyloxypropyl) trimethoxysilane, (3-mercaptopropyl) trimethoxysilane, 3-acrylamidopropyltrimethoxysilane or any mixture thereof.

In some embodiments, the solid base object contains a grafting aid. In some embodiments, the grafting aid provides a higher concentration of functional moieties that are graftable to the multifunctional material. In some embodiments, the grafting aid comprises allyl methacrylate, allyl acrylate, vinyl methacrylate, glycidyl methacrylate, alkynes, aziridines, isocyanides or any mixture thereof. In some embodiments, the grafting aid comprises a reversible-addition fragmentation chain transfer (RAFT) agent that aids in grafting the multifunctional material.

In some embodiments, the process further comprises contacting the multifunctional material patterned on and grafted to the base object with a coating material that interacts with the multifunctional material to coat the multifunctional material with the coating material. In some embodiments, the coating material comprises a metal ion. In some embodiments, the metal ion comprises platinum, gold, silver, copper, nickel, iron or any mixture thereof. In some embodiments, the process further comprises reducing the metal ion to elemental metal. In some embodiments, the coating material comprises inorganic nanoparticles.

In some embodiments, the liquid composition further comprises a solvent in which the photo-initiator and the multifunctional material are dispersed.

In some embodiments, the process further comprises curing the layer of the multifunctional material. In some embodiments, the curing is accomplished using light at a suitable wavelength (e.g., 405 nm) for a suitable length of time. (e.g., 0.5-60 minutes) at a suitable temperature (e.g., 20-100° C.).

In some embodiments, the multifunctional material comprises graftable groups that react with the surface of the solid base object when irradiated by the patterned light to form covalent bonds with the surface of the solid base object. In some embodiments, the graftable groups comprise acrylates, methacrylates, thiols, allyls, acrylamides, methacrylamides, epoxides, azides or any mixture thereof. In some embodiments, the multifunctional material comprises a photo-reactive component, a photo-polymerizable monomer or a photo-polymerizable polymer. In some embodiments, the multifunctional material comprises 3-mercaptopropionic acid, thioglycolic acid, 6-mercaptohexanoic acid, 8-mercaptooctanoic acid, 4-mercaptobenzoic acid, 1,6-hexanedithiol, benzene-1,4-dithiol, 2,2′-(ethylenedioxy) diethanethiol, acrylic acid, 2-carboxyethyl acrylate, 2-hydroxyethyl methacrylate, acrylamide, 1,6-hexanediol diacrylate, poly(ethylene glycol) dithiol, mercaptopropyl-terminated polydimethylsiloxane, (mercaptopropyl)methylsiloxane-dimethylsiloxane copolymers, mathacryloxypropyl-terminated polydimethylsiloxane, (methacryloxypropyl)methylsiloxane-dimethylsiloxane copolymer or any mixture thereof.

In some embodiments, the layer of the multifunctional material grafted on the surface of the solid base object is further reactive. In some embodiments, the layer of the multifunctional material comprises a functional group selected from the group consisting of a hydrophobic group, a hydrophilic group, a polymerizable group, a swellable group, a group reactive with light, a group reactive with heat, a group reactive with electricity, a chemically reactive functional group and any combination thereof. In some embodiments, the functional group comprises carboxylic acids, thiols, alcohols, amines, alkenes, alkynes, amides, fluorinated compounds, siloxanes, polysiloxanes, acrylates, polyacrylates, methacrylates, allyls, acrylamides, methacrylamides, epoxides, growth factors, proteins, fluorescent dyes, poly(ethyleneglycol) or any mixture thereof.

In some embodiments, the photo-initiator comprises benzophenone (BP), isopropylthioxanthone (ITX), camphorquinone (CQ), ethyl 4-dimethylaminobenzoate (EDAB), ethyl (2,4,6-trimethylbenzoyl)phenylphosphinate (TPO-L), lithium phenyl-2,4,6-trimethylbenzoylphosphinate (LAP), tris(2,2′-bipyridyl) ruthenium (II) chloride, sodium persulfate, 2-dimethylamino-2-(4-methyl-benzyl)-1-(4-morpholin-4-yl-phenyl)-butan-1-one, thioxanthone anthracene, diphenyl (2,4,6-trimethylbenzoyl) phosphine oxide, phenylbis(2,4,6-trimethylbenzoyl) phosphine oxide, sodium persulfate, 2-hydroxy-4′-(2-hydroxyethoxy)-2-methylpropiophenone, benzoyl peroxide, or any mixture thereof.

In some embodiments, the patterned object is rinsed in a solvent after grafting to remove unreacted components and optionally dried.

In the present application, a dispersion comprises molecules, particles or droplets of one or more materials distributed with some degree of uniformity between the molecules, particles or droplets of a matrix material. Dispersions include, for example, mechanical mixtures, suspension and solutions in which two or more materials are distributed to provide a bulk material in which concentrations of the two or more materials are relatively evenly distributed throughout the bulk material.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a schematic diagram of a tomographic printing system and a method of overprinting onto a solid base object.

FIG. 2 depicts a reaction scheme of allyl groups as functional moieties on the base object reacting with the thiol group of 3-mercaptoprpionic acid via thiol-ene click chemistry only in regions of light illumination during VAM printing.

FIG. 3 depicts a scanning electron microscope (SEM) image of 1 mm discs patterned with 3-mercaptopropionic acid grafted to the surface of a base object containing 20 wt % allyl methacrylate.

FIG. 4 depicts crystal formation of silver on the surface of the object shown FIG. 3 following addition of a silver nanoparticle coating material.

FIG. 5 depicts an optical image of a 3D printed object patterned with 1 mm discs of 3-mercaptopropionic acid with silver and copper coating materials.

FIG. 6 depicts a scanning electron microscope SEM image of the patterned region of the object of FIG. 5 containing the copper and silver coating materials coated on the grafted 3-mercaptopropionic acid.

FIG. 7 depicts a cross-section of the patterned 3D object of FIG. 5 showing a 20 μm thick layer containing the grafted 3-mercaptopropionic acid and the silver and copper coating coated thereon.

FIG. 8 depicts FTIR spectra of a cylindrical base object, 2-carboxyethyl acrylate (CEA) monomer, and the base object grafted with CEA.

FIG. 9 depicts FTIR spectra of a cylindrical base object, 2-carboxyethyl acrylate (CEA) monomer, and the base object grafted with CEA, in the region of the O—H bond.

FIG. 10 depicts an optical image of acrylate polymer rings grafted to the surface of a glass cylinder with 3-(trimethoxysilyl) propyl methacrylate (TMSPMA) primer material.

FIG. 11 depicts optical images of cylindrical objects made from polymethylmethacrylate (PMMA) and having two rings overprinted thereon using a liquid composition listed in Table 8 as Index D and having silver and copper coating layers coated on the two rings.

FIG. 12 depicts an optical image of a cylindrical object made from PMMA and having two rings overprinted thereon using a liquid composition listed in Table 8 as Index E liquid composition.

FIG. 13 depicts an optical image of a cylindrical object made from a methacrylate-based resin (Tough1500) and having rings overprinted thereon using a liquid composition listed in Table 10 and having copper coating layers coated on the rings.

FIG. 14 depicts a graph of measured linewidth (μm) vs. nominal linewidth (μm) for the coated rings on the cylindrical object shown in FIG. 13.

FIG. 15 depicts an optical image of a cylindrical object made from a methacrylate-based resin (Tough1500) and having a coil overprinted thereon using a liquid composition listed in Table 12 and having a conductive copper coating on the coil.

FIG. 16 depicts optical images of a square rod made from a methacrylate-based resin (Tough1500) and having four different patterns overprinted on each side of the rod using a liquid composition listed in Table 14 and having a copper coating on the four patterns.

FIG. 17 depicts an optical image of a sheet made from polyethylene terephthalate (PET) having linear traces overprinted thereon using a composition listed in Table 17 and having copper coating layers coated on the traces.

FIG. 18 depicts an optical image of a template having a series of 1 cm lines ranging from 40 μm to 400 μm in width overprinted thereon using a composition listed in Table 17 and having copper coating layers coated on the lines.

FIG. 19 depicts a graph of light penetration depth (μm) vs. concentration of photo-initiator (wt % of ITX (isopropylthioxanthone)) for the lines shown in FIG. 18.

### DETAILED DESCRIPTION

The solid base object comprises a material, for example a polymeric material, glass, a metallic material and the like, to which the multifunctional material is graftable. In some embodiments, the solid base object comprises a polymeric material. In some embodiments, the polymeric material of the base object comprises an acrylate-based polymer, epoxide-based polymer, thiol-ene-based polymer, urethane-based polymer, siloxane-based polymer. In some embodiments, the solid base object contains functional moieties that are graftable to the multifunctional material. In some embodiments, the functional moieties comprise acrylates, methacrylates, thiols, allyls, acrylamides, methacrylamides, epoxides, azides or any mixture thereof. In some embodiments, the base object contains a combination of functional moieties (e.g., allyl groups, acrylate groups, etc.) and a reversible-addition fragmentation chain transfer (RAFT) agent to aid in the grafting step. Some examples of RAFT agents include 2-cyano-2-propyl benzodithioate, 4-cyano-4-(phenylcarbonothioylthio) pentanoic acid, 2-cyano-2-propyl dodecyl trithiocarbonate, 4-cyano-4-[(dodecylsulfanylthiocarbonyl)sulfanyl)pentanoic acid, 2-(dodecylthiocarbonothioylthio)-2-methylprpionic acid, cyanomethyl dodecyl trithiocarbonate and any mixture thereof. RAFT agents themselves do not have a graftable moiety. In some embodiments, the surface of the solid base object comprises a layer of primer material to which the multifunctional material is covalently graftable. In some embodiments, the primer material comprises functional moieties that are graftable to the multifunctional material. In some embodiments, functional moieties of the primer material comprise acrylates, methacrylates, thiols, allyls, acrylamides, methacrylamides, epoxides, azides or any mixture thereof. In some embodiments, the primer material comprises 3-(trimethoxysilyl) propyl acrylate (TMSPA), 3-(trimethoxysilyl) propyl methacrylate (TMSPMA), allyltrimethoxysilane, (3-glycidyloxypropyl) trimethoxysilane, (3-mercaptopropyl) trimethoxysilane, 3-acrylamidopropyltrimethoxysilane or any mixture thereof.

The multifunctional material is graftable on to the surface of the solid base object. Therefore, the multifunctional material comprises reactive functional groups that can undergo a photo-induced reaction with the surface of the base object to form covalent bonds. In some embodiments, the multifunctional material comprises one or more photo-reactive component and/or photo-polymerizable monomers and/or photo-polymerizable polymers. In some embodiments, the multifunctional material comprises functional groups such as acrylates, methacrylates, thiols, allyls, acrylamides, methacrylamides, epoxides, azides or any mixture thereof. In some embodiments, the multifunctional material comprises an acrylate-based monomer and/or polymer, for example acrylates, diacrylates, triacrylates, methacrylates, dimethacrylates, acrylamides, polyacrylates, polymethacrylates, polyacrylamides and the like. In some embodiments, the multifunctional material comprises a thiol-based compound, for example dithiols, mercaptosiloxanes, mercaptocarboxylic acids and the like. In some embodiments, the multifunctional material comprises a hydroxyl-based compound, for example diols, aminodiols and the like. Mixtures of different multifunctional materials can improve print quality in a VAM printing process.

In some embodiments, the multifunctional material comprises 3-mercaptopropionic acid, thioglycolic acid, 6-mercaptohexanoic acid, 8-mercaptooctanoic acid, 4-mercaptobenzoic acid, 1,6-hexanedithiol, benzene-1,4-dithiol, 2,2′-(ethylenedioxy) diethanethiol, poly(ethylene glycol) dithiol, mercaptopropyl-terminated polydimethylsiloxane, (mercaptopropyl)methylsiloxane-dimethylsiloxane copolymers, methacryloxypropyl-terminated polydimethylsiloxane, (methacryloxypropyl)methylsiloxane-dimethylsiloxane copolymer, 1,6-hexanediol diacrylate (HDDA), bisphenol A glycerolate (1 glycerol/phenol) diacrylate, an aliphatic urethane diacrylate, di-pentaerythritol pentaacrylate, a diurethane dimethacrylate (DUDMA), trimethylolpropane triacrylate (TMPTA), bisphenol A ethoxylate dimethacrylate, triethylene glycol dimethacrylate, glycidyl methacrylate (GMA), bisphenol A-glycidyl dimethacrylate (BisGMA), 3-(trimethoxysilyl) propyl acrylate (TMSPA), 3-(trimethoxysilyl) propyl methacrylate (TMSPMA), gelatin methacrylate, poly(ethylene glycol) diacrylate (PEGDA), hexyl acrylate, 2-[[(butylamino)carbonyl]oxy]ethyl acrylate, trimethylolpropane triacrylate, ethoxylated bisphenol A dimethacrylate, tricyclodecane dimethanol diacrylate, 2-carboxyethyl acrylate, 2-hydroxyethyl methacrylate, 2-hydroxyethyl acrylate, ethyl methacrylate, hydroxypropyl methacrylate, hydroxybutyl methacrylate, ethylene glycol methyl ether methacrylate, 2-hydroxy acrylate, isobornyl acrylate, glycidyl acrylate, glycidyl methacrylate, methacrylate, acrylate, 2-phenoxyethylacrylate, tert-butyl acrylate, n-butyl acrylate, ethyl acrylate, benzyl acrylate, methyl acrylate, lauryl acrylate, vinyl acrylate, isobutyl acrylate, (2-methoxyethyl) acrylate, 2-ethylhexyl acrylate, ethylene glycol phenyl ether acrylate, acrylamide, N-isopropylacrylamide (NIPAAm), acrylic acid, methacrylic acid, hexyl acrylate, hexyl methacrylate, or pentaerythritol tetraacrylate, 1,4-butanediol diacrylate or any mixture thereof.

In some embodiments, the multifunctional material preferably comprises 3-mercaptoproionic acid, 2-carboxyethyl acrylate, 2-hydroxyethyl methacrylate, 2-hydroxyethyl acrylate, acrylic acid, methacrylic acid or any mixture thereof.

In some embodiments, the multifunctional material is present in the liquid composition in an amount in a range of about 700-12750 mM. In some embodiments, the amount of the multifunction material is in a range of about 1000-8000 mM, or about 2800-4200 mM.

Choice of photo-initiator depends to some extent on the nature the multifunctional material. Photo-initiators are generally known in the art. Suitable photo-initiators, especially for acrylate-based or thiol-ene-based monomers, include, for example benzophenone (BP), isopropylthioxanthone (ITX), thioxanthone anthracene (TXA), camphorquinone (CQ), ethyl 4-dimethylaminobenzoate (EDAB), ethyl (2,4,6-trimethylbenzoyl)phenylphosphinate (TPO-L), lithium phenyl-2,4,6-trimethylbenzoylphosphinate (LAP), 2-benzyl-2-dimethylamino-1-(4-morpholinophenyl)-butanone-1,2-dimethylamino-2-(4-methyl-benzyl)-1-(4-morpholin-4-yl-phenyl)-butan-1-one, diphenyl (2,4,6-trimethylbenzoyl) phosphine oxide, phenylbis(2,4,6-trimethylbenzoyl) phosphine oxide, sodium persulfate; 2-hydroxy-4′-(2-hydroxyethoxy)-2-methylpropiophenone and any mixture thereof.

In some embodiments, the photo-initiator is present in the photoresin formulation in a concentration in a range of about 0.01-100 mM, the desired concentration being somewhat dependent on light penetration depth volume. For example, a concentration range of 0.3-5 mM is desirable when the light penetration depth volume is 2 cm or less.

A solvent may be used to disperse the photo-initiator, multifunctional material and any other components of the liquid composition prior to irradiating. In some embodiments, the liquid composition comprises a homogeneous solution of the photo-initiator, multifunctional material and any other components in a solvent. When a film of a photo-initiator on the surface of the base object is desired prior to contacting the surface of the base object with the liquid composition to provide extra photo-initiator molecules for more efficient grafting of the multifunctional material, the surface may be contacted with a solution of the same or a different photo-initiator and the solution partially or completely dried to provide the film of the same or different photo-initiator on the surface of the object. In this case, the solution of the same or different photo-initiator may comprise a solvent that is the same or different as the solvent used to disperse the photo-initiator in the liquid composition, multifunctional material and any other components prior to irradiating the liquid composition.

The desired solvent depends to some extent on the solubilities of the photo-initiator, multifunctional material and any other components, as well as the effect that the solvent might have on the material that comprises the solid base object. The solvent may be organic, aqueous or a mixture thereof. Some examples of solvents include water, aqueous solutions, alcohols (e.g., ethanol, isopropanol, t-butanol), ketones (e.g., acetone), ethers (tetrahydrofuran), aromatics (e.g., toluene), alkanes (e.g., heptane, n-octane), chlorinated alkanes, other substituted alkanes and the like and mixtures thereof. In some embodiments, the solvent is toluene, ethanol, t-butanol, acetone, acetonitrile, water (e.g., deionized water) or any mixture thereof. The aforementioned solvents are also generally useable for rinsing the patterned base object after grafting. In some embodiments, isopropanol and/or ethanol is used to rinse the patterned base object after grafting.

The multifunctional material together with any solvent make up the bulk of the mass of the liquid composition. In some embodiments, the amount of solvent comprises no more than 50 wt % of the liquid composition based on the combined weight of multifunctional material and solvent. In other embodiments, when a solvent is present in the liquid composition, the amount of solvent comprises 1-25 wt % or 1-15 wt % or 1-10 wt %, based on the combined weight of the multifunctional material and solvent.

In some embodiments, one or more surface-active components may be present in the liquid compositions. Some examples of surface-active components include poloxamers, polysorbates, ethoxylated fatty alcohols and mixtures thereof. Poloxamers are non-ionic triblock copolymers composed of a central hydrophobic chain of polyoxypropylene (poly(propylene oxide)) flanked by two hydrophilic chains of polyoxyethylene (poly(ethylene oxide)). Some examples are Pluronic™ F-68, Pluronic™ F-127, Pluronic™ F-38 and Pluronic™ F-108. Polysorbates are derived from ethoxylated sorbitan esterified with fatty acids. Some examples of poloysorbates are Tween™ 20 and Tween™ 80 (Sigma Aldrich). Ethoxylated fatty alcohols, such as Brij™ S100 and Brij™ S10. In other embodiments, when a surface-active component is present in the liquid composition, the surface-active component is present in an amount in a range of 0.1-1.0 wt %, based on total weight of the liquid composition.

In some embodiments, a printing aid may be included in the liquid composition to assist with the VAM printing. In some embodiments, the printing aid comprises a reducing agent. Reducing agents include, for example, phosphines (e.g., triphenyl phosphine), amines (e.g., methyldiethanolamine (MDEA)), thiols (e.g., propan-1,3-dithiol) and the like, or any mixture thereof. In some embodiments, the reducing agent comprises a potent, air-stable reducing agent, without readily abstractable hydrogen atoms, which reactivates the surface of the substrate after the surface of the substrate has reacted with oxygen, thereby regenerating reactive radicals. In some embodiments, the potent, air-stable reducing agent comprises a non-amine reducing agent, for example triphenylphosphine, tris(o-tolyl) phosphine, 3,3′,3″-phosphanetriyltris(benzenesulfonic acid) trisodium salt, 3,3′,3″-phosphanetriyltris(benzenesulfonic acid) trisodium salt, triphenylphosphite, tris(2,4-di-tert-butylphenyl) phosphite, ethyldiphenylphosphinite, methyldiphenylphosphinite, or any mixture thereof. Reducing agents may be utilized at a concentration in a range of 1-150 mM. In some embodiments, the non-amine reducing agent is present in the liquid composition in an amount in a range of about 0.4-400 mM, for example about 40-250 mM, or about 4-200 mM, or about 80-160 mM, or about 20-40 mM.

In some embodiments, the liquid composition comprises a crosslinker. In some embodiments, the crosslinker comprises poly(ethylene glycol) diacrylate, poly(ethylene glycol) diacrylate (e.g., PEGDA 575 (Mn 575 g/mol) or PEGDA 600 (Mn 600 g/mol)), diurethane dimethacrylate (DUDMA), hexanediol diacrylate, trimethylolpropane triacrylate (TMPTA), or any mixture thereof. In some embodiments, the crosslinker is present in the liquid composition in an amount in a range of about 100-1950 mM. In some embodiments, the amount of crosslinker is in a range of about 600-1800 mM, or about 1400-1600 mM.

In some embodiments, the liquid composition comprises a wetting agent. In some embodiments, the wetting agent comprises DOWSIL™ 57 Additive, Capstone™ FS-3100, DISPERBYK™-2205 or any mixture thereof. In some embodiments, the wetting agent is present in the liquid composition in an amount in a range of about 0.05-0.75% (w/w). In some embodiments, the amount of wetting agent is in a range of about 0.1-0.5% (w/w), or about 0.2-0.3% (w/w).

In some embodiments, the liquid composition comprises a viscosity modifier. In some embodiments, the viscosity modifier comprises ethyl cellulose (e.g., ethyl cellulose 46 cP). In some embodiments, the viscosity is in a range of about 1-100,000 cP. In some embodiments, the viscosity is in a range of about 100-10,000 cP. In some embodiments, the viscosity is in a range of about 300-5,000 cP. In some embodiments, the viscosity is in a range of about 1,000-2,000 cP. In some embodiments, the viscosity modifier is present in the liquid composition in an amount in a range of about 0.25-5% (w/w). In some embodiments, the amount of viscosity modifier is in a range of about 0.75-3% (w/w), or about 1-2% (w/w). Rheological measurements were performed using a Discovery™ HR-20 parallel plate rheometer equipped with a 40 mm diameter top plate and a bottom Peltier plate for temperature control. The temperature was set to 25° C., the gap size was set to 500 μm, and the viscosity was measured at a shear rate of 1 s⁻¹.

In some embodiments, the liquid composition comprises a defoamer. In some embodiments, the defoamer comprises antifoam 204, BYK-057 or a mixture thereof. In some embodiments, the defoamer is present in the liquid composition in an amount in a range of about 0.005-0.5% (w/w). In some embodiments, the amount of defoamer is in a range of about 0.01-0.1% (w/w), or about 0.02-0.03% (w/w).

In a variation of the process, hereinafter called the ‘dry process’, the solid base object is first treated with a liquid photoresin composition comprising a photo-initiator and a multifunctional material to coat or lightly swell the surface of the solid base object with the photoresin. The base object is then removed from the liquid photoresin and the excess is removed. The base object, having a thin film coating of the liquid photoresin composition on the surface, is then placed on a rotating stage and irradiated with light projections that trigger polymerization at the surface of the solid base object. In some embodiments, the liquid photoresin is selectively irradiated, for example with patterned light that is calculated and projected using tomographic imaging. For example, selectively irradiating is accomplished with 2D light patterns calculated using computed using tomographic methods and/or according to the geometric intersection of the projected beam and the solid to be patterned. In this manner, the overprinting is not performed in a liquid volume where diffusion is difficult to manage but on an un-submerged (dry) object that has a thin layer of the liquid photoresin on the surface. In some embodiments, the thin film coating has a thickness in a range of about 10-5,000 μm. In some embodiments, the thickness is in a range of about 50-1,000 μm, for example about 100-200 μm. Due to the lack of a large volume of liquid, the photoresin does not diffuse and the pattern is better replicated onto the surface of the solid base object. The dry process improves print fidelity and print quality by avoiding the problem of oxygen diffusion that occurs when printing in a volume of liquid photoresin. Thus, the solid base object the solid base object may be placed in an oxygen-containing environment for irradiation after being removed from the liquid photoresin composition. However, if desired, as discussed above, the solid base object could be placed in an inert environment for irradiation after being removed from the liquid photoresin composition.

The dry process has other benefits. The dry process also allows for a higher concentration of photo-initiator to be used which also improves print quality and reduces printing time. The dry process also permits the use of low viscosity photoresins where the impact of oxygen diffusion is compensated by higher concentration of photo-initiator. In some embodiments, the photo-initiator is in the liquid photoresin composition at a concentration in a range of about 3-300 mM (about 0.1-10% w/w). In some embodiments, concentration of the photo-initiator is in a range of about 10-200 mM, or about 10-100 mM, for example about 30-60 mM. The dry process also allows the use of lower intensity light over a shorter time. In some embodiments, the patterned light has an intensity in a range of about 25-100 mW/cm². In some embodiments, the intensity is in a range of about 25-50 mW/cm². In some embodiments, the selectively irradiating is performed for a time in a range of about 1-60 seconds. In some embodiments, the time is in a range of 10-40 seconds, for example 15-30 seconds. Larger volume base objects can also be overprinted because light is not absorbed by the large volume of photoresin. Significantly less material wastage occurs because only a thin surface coating is applied prior to overprinting. Also, the liquid photoresins can be applied to printing on 2D surfaces on commonly used flexible substrates to make high resolution conductive traces, opening up applications to high throughput low-cost manufacturing of transparent conductive traces.

The dry process can be used to graft polymers or functional groups or adhere polymers with functional groups to existing surfaces of the base object to afford new properties. Depending on the surface properties desired, an appropriate grafting method and functional groups/polymers are chosen accordingly.

In some embodiments, the process further comprises curing the layer of multifunctional material grafted to the surface of the solid base object. Curing is a process that produces the toughening or hardening of a polymer material by cross-linking of polymer chains. Curing can be induced by heat, radiation (e.g., light), electron beams, or chemical additives. In some embodiments, the curing is accomplished using light at a suitable wavelength (e.g., 405 nm) for a suitable length of time. (e.g., 0.25-60 minutes) at a suitable temperature (e.g., 20-100° C.).

In some embodiments, the process further comprises contacting the multifunctional material patterned on and grafted to the base object with a coating material that interacts with the multifunctional material to coat the multifunctional material with the coating material. In some embodiments, the coating material comprises a metal ion. In some embodiments, the metal ion comprises platinum, gold, silver, copper, nickel, iron or any mixture thereof. The metal ion may be provided in the form of a metal salt, for example, halides (e.g., chlorides, bromides, iodides), organic carboxylates, nitrates, sulfates, carbonates, phosphates, chlorates, brominates, iodates or mixtures thereof. In some embodiments, metal ions may be included in the liquid composition prior to overprinting to provide metal ions directly in the multifunctional material patterned on the solid base object. In some embodiments, the process further comprises reducing the metal ion to elemental metal. In some embodiments, the coating material comprises inorganic nanoparticles. Inorganic nanoparticles include, for example, metal nanoparticles (e.g., platinum, gold, silver, copper, nickel and iron nanoparticles), metal oxides (e.g., platinum, gold, silver, copper, nickel, zinc, magnesium, aluminum, silicon iron and calcium oxides) or ceramic/inorganic precursors (e.g., SiC, Si₃N₄, CaCO₃).

Volumetric additive manufacturing (VAM) is a 3D printing technology that uses photoresin formulations to fabricate complex 3D objects at once while reducing or eliminating the need for support structures. Volumetric printing methods include beam superposition (such as dual-color photopolymerization printing), light sheet printing (which implements a linearly swept light sheet combined with orthogonal projections to crosslink material at the intersection) and tomographic-based approach (which employ tomographic projections to deliver complex 3-dimensional light dosages). Computed axial lithography is a tomographic-based approach. The VAM technique is very fast and yields smoother objects with no layers and fewer surface artifacts than other volumetric techniques such as stereolithography (SLA) and digital light processing (DLP). Further, VAM permits printing around an existing object (overprinting).

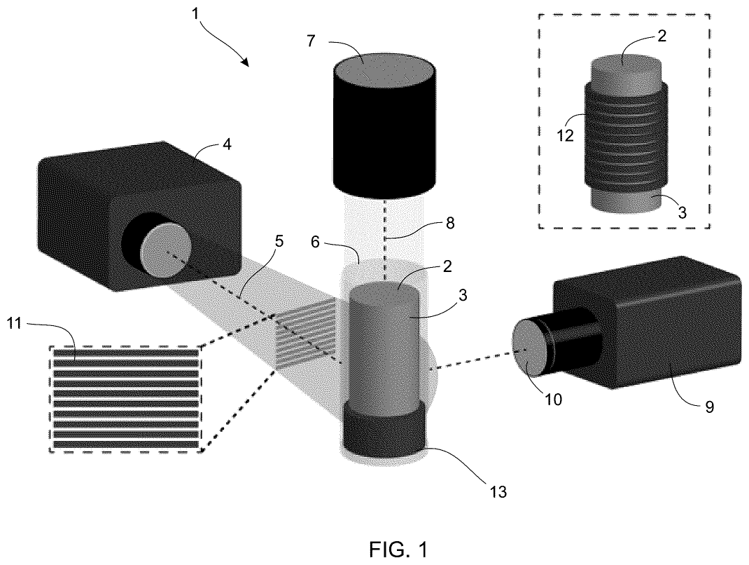

With reference to FIG. 1, for overprinting, a tomographic printing system 1 for volumetric additive manufacturing (VAM) involves obtaining patterned light images 11 on a solid base object 2 through the reverse of computed tomography (CT) and using a projector 4 to project the patterned light images 11 in a blue/violet light beam 5 towards the solid base object 2 immersed in the liquid composition contained in a container 6, preferably being rotated on a rotating stage 13. Patterns 11 are calculated so that the shape of the light dose distribution matches a surface 3 of the solid base object 2 to be overprinted. The liquid composition in the container 6 is illuminated with red light projected into the container 6 by a red light source 7, for example a red light emitting diode (LED). A camera 9 having a filter 10 to permit passage of the red light may be used to monitor the progress of the tomographic printing process. When the liquid composition locally absorbs projected light doses 5, the liquid composition reacts with the solid base object 2 to form a layer 12 on the surface 3 of the solid base object 2 (see inset) only where the surface 3 has been illuminated by the patterned light 11. In other words, when and where the local light dose 5 illuminates the surface 3 of the solid base object 2, the multifunctional material is grafted to the surface 3, while the rest of the print volume remains unreacted and the rest of the surface 3 of the solid base object 2 remains ungrafted.

In a variation of the composition, a photoresin composition has a viscosity of about 300 cP or higher and comprises: a reactive monomer with no hydrogen atoms having a bond-dissociation energy of less than about 410 kJ/mol; a non-amine reducing agent; and, a Norrish Type II photo-initiator. Bond-dissociation energy, D, is defined as the enthalpy per mole required to break a given bond of some specific molecular entity by homolysis, in accordance with the standard definition provided by the International Union of Pure and Applied Chemistry (‘bond-dissociation energy’ in IUPAC Compendium of Chemical Terminology, 3rd ed. International Union of Pure and Applied Chemistry; 2006. Online version 3.0.1, 2019. https://doi.org/10.1351/goldbook.B00699).

This variation of the composition permits performing graft photopolymerization on polymer substrates in an ambient environment (i.e., an oxygen-containing environment). The photoresin composition has:
a high viscosity to minimize reintroduction of oxygen from the environment into a coating film of the composition on a surface of a substrate (e.g., a solid base object) and ultimately at the surface of a substrate;
a reactive monomer that reacts with photogenerated surface radicals, covalently bonding to the surface, and imparting a functional group, the reactive monomer not having readily abstractable hydrogen atoms (e.g., no amines, no alcohols with αC—H bonds, no tertiary C—H bonds, etc.) so that polymerization initiates at the surface of the substrate rather than in the bulk of the reactive monomer;
a potent, air-stable reducing agent, without readily abstractable hydrogen atoms, which reactivates the surface of the substrate after the surface of the substrate has reacted with oxygen, thereby regenerating reactive radicals; and,
a Norrish Type II photo-initiator (Norrish Type I photoreactions encourage bulk polymerization, which is preferably avoided).

In some embodiments, the reactive monomer comprises acrylic acid, 2-acrylamido-2-methylpropane sulfonic acid, sodium 2-acrylamido-2-methylpropane sulfonate, vinylsulfonic acid, sodium vinylsulfonate, ammonium vinylsulfonate, vinyl phosphonic acid, sodium vinyl phosphonate, ammonium vinyl phosphonate, 4-styrenesulfonic acid, sodium 4-styrenesulfonate or any mixture thereof. In some embodiments, the reactive monomer is present in the composition in an amount of 99.8 mol % or less. In some embodiments, the reactive monomer is present in the composition in a range of about 50-99 mol %, for example 90-95 mol %.

In some embodiments, the composition comprises a non-amine reducing agent. The non-amine reducing agent is capable of rapidly converting peroxyl radicals into more reactive free radicals permitting the surface of the substrate to be grafted even after the surface has already reacted with oxygen. In some embodiments, the non-amine reducing agent comprises triphenylphosphine, tris(o-tolyl)phosphine, 3,3′,3″-phosphanetriyltris(benzenesulfonic acid) trisodium salt, 3,3′,3″-phosphanetriyltris(benzenesulfonic acid) trisodium salt, triphenylphosphite, tris(2,4-di-tert-butylphenyl) phosphite, ethyldiphenylphosphinite, methyldiphenylphosphinite, or any mixture thereof. In some embodiments, the non-amine reducing agent is present in the composition in an amount in a range of about 0.4-400 mM, for example about 4-200 mM or about 20-40 nM.

In some embodiments, the composition comprises a Norrish Type II photo-initiator. In some embodiments, the Norrish Type II photo-initiator comprises and aromatic ketone. In some embodiments, the Norrish Type II photo-initiator comprises 2-isopropylthioxanthone, 4-isopropylthioxanthone, 2-chlorothioxanthone, benzophenone, 4-chlorobenzophenone, 4,4′-dichlorobenzophenone, xanthone, anthraquinone, 2-methylanthraquinone, 2-tert-butylanthraquinone, 9-fluorenone, camphorquinone, or any mixture thereof. In some embodiments, the Norrish Type II photo-initiator is present in the composition in an amount in a range of about 0.01-20 mol %, for example about 0.1-10 mol %.

In some other processes, print fidelity and quality is compromised by diffusion of reactive species in the liquid photoresin used to functionalize the base object. The diffusion of reactive species makes it particularly difficult to print large and small features at once since each feature size requires different times to print. In addition, large relief patterns of a few hundred microns result from printing in a liquid photoresin. This can be overcome by removing oxygen from the resin and printing in a sealed container however these procedures are not practical.

Therefore, in some embodiments, the composition further comprises an oxygen-diffusion inhibitor with no hydrogen atoms having a bond-dissociation energy of less than about 410 kJ/mol. The oxygen-diffusion inhibitor inhibits oxygen diffusion in the composition without lowering grafting efficiency to a surface of a solid object of a polymer formed from the reactive monomer. The oxygen-diffusion inhibitor has a viscosity that is sufficiently high to ensure that the viscosity of the photoresin composition remains 300 cP or higher. In some embodiments, the oxygen-diffusion inhibitor comprises 1-butyl-3-methylimidazolium chloride, 1-ethyl-3-methylimidazolium chloride, 1-butyl-1-methylpyrrolidinium chloride, N-butylpyridinium chloride, 1-butyl-3-methylimidazolium tetrafluoroborate, 1-ethyl-3-methylimidazolium tetrafluoroborate, 1-butyl-1-methylpyrrolidinium tetrafluoroborate, N-butylpyridinium tetrafluoroborate, 1-butyl-3-methylimidazolium hexafluorophosphate, 1-ethyl-3-methylimidazolium hexafluorophosphate, 1-butyl-1-methylpyrrolidinium hexafluorophosphate, N-butylpyridinium hexafluorophosphate, 1-butyl-3-methylimidazolium acrylate, 1-ethyl-3-methylimidazolium acrylate, 1-butyl-1-methylpyrrolidinium acrylate, N-butylpyridinium acrylate, 2-acrylamido-2-methylpropane sulfonic acid, sodium 2-acrylamido-2-methylpropane sulfonate, ammonium 2-acrylamido-2-methylpropane sulfonate tert-butylammonium 2-acrylamido-2-methylpropane sulfonate, tert-octylammonium 2-acrylamido-2-methylpropane sulfonate, 1-butyl-3-methylimidazolium 2-acrylamido-2-methylpropane sulfonate, 1-ethyl-3-methylimidazolium 2-acrylamido-2-methylpropane sulfonate, 1-butyl-1-methylpyrrolidinium 2-acrylamido-2-methylpropane sulfonate, N-butylpyridinium 2-acrylamido-2-methylpropane sulfonate, poly(tert-butyl methacrylate), poly(dimethyl siloxane), poly(α-methylstyrene), 1,3-di-tert-butyl imidazolium acrylate, 1,3-di-tert-butyl imidazolium 2-acrylamido-2-methylpropane sulfonate, N-tert-butyl pyridinium acrylate, N-tert-butyl pyridinium 2-acrylamido-2-methylpropane sulfonate, or any mixture thereof. In some embodiments, the oxygen-diffusion inhibitor is present in the composition in a range of about 10-90 mol %, for example about 20-80 mol % or about 40-60 mol %.

The viscosity of the photoresin composition is about 300 cP or higher. In some embodiments, the viscosity is in a range of 300-5,000 cP. In some embodiments, the viscosity is in a range of 1,000-2,000 cP.

In some embodiments, when the composition is utilized in a volumetric additive manufacturing (VAM) process, the composition is coated on to a surface of a base object to provide a coating layer having a thickness in a range of 10-5,000 μm. In some embodiments, the thickness is in a range of 50-1,000 μm, or 100-200 μm. In some embodiments of the VAM process, the composition is irradiated with light having an intensity in a range of 1-1000 mW/cm². In some embodiments, the intensity is in a range of 10-250 mW/cm² or 25-100 mW/cm².

### EXAMPLES

### Materials and Methods

### Materials

### Materials Used for Base Object:

Various copolymers of Diurethane dimethacrylate (DUDMA, about 8,000-10,000 cP, Esstech, Inc.);
Various copolymers of Poly(ethylene glycol) diacrylate (Mn 700 g/mol, PEGDA 700, Sigma-Aldrich);
Borosilicate glass

### Photo-Initiators:

Ethyl (2,4,6-trimethylbenzoyl)phenyl phospinate (TPO-L, Oakwood Products, Inc.);
Benzophenone (Sigma-Aldrich)

### Primer Materials:

3-(trimethoxysilyl) propyl methacrylate (TMSPMA, Sigma-Aldrich)

### Grafting Aids (Provide Additional Functional Moieties in the Base Object):

2-cyano-2-propyl benzodithioate (RAFT agent, TCI America);
Allyl methacrylate (AMA, TCI America)

### Multifunctional Materials in Liquid Composition:

3-mercaptoproionic acid (MPA, Sigma-Aldrich);
2-carboxyethyl acrylate (CEA, Sigma-Aldrich);
2-hydroxyethyl methacrylate (HEMA, Sigma-Aldrich);
2-hydroxyethyl acrylate (HEA, Sigma-Aldrich);
Poly(ethylene glycol) diacrylate (Mn 575 g/mol, PEGDA 575, Sigma-Aldrich);
Poly(ethylene glycol) diacrylate (Mn 600 g/mol, PEGDA 600, Sigma-Aldrich);
Diurethane dimethacrylate (DUDMA, about 8,000-10,000 cP, Esstech, Inc.);

### Additives:

N-methyldiethanolamine (MDEA, Sigma-Aldrich)

### Solvents:

Acetonitrile (CH₃CN)

### Coating Materials:

### Silver Layer:

0.1 M solution of silver nitrate in deionized water;
Concentrated ammonia solution

### Copper Layer:

Copper (II) sulfate pentahydrate (CuSO₄·5H₂O);
Sodium potassium tartrate tetrahydrate;
Sodium hydroxide (NaOH);
Deionized water
37 wt % formaldehyde solution

### Photoresin Preparation for Base Object and Liquid Composition for Grafting

Photoresins for 3D printing the base object and grafting of the liquid composition via volumetric additive manufacturing (VAM) were prepared by mixing all components in a container. The composition of these photoresins can be found in Table 1 and Table 2, respectively. To the container, the photocurable monomer(s) and/or multifunctional material(s) are added, followed by the photo-initiator. All components listed above were used as is. The photoresin was mixed using a plenary mixer at 2000 rpm for 4-5 min, followed by 2200 rpm for 30 s for high viscosity photoresins (Table 1, Table 2 index C-K) and a vortex mixer for 1 min for low viscosity photoresins (Table 2 index A-B). The photoresin was stored in the dark in a fridge at 4° C.

TABLE 1
Photoresins for Fabrication of Base Object
with Graftable Functional Moieties.

| Index | Material | wt % |
|---|---|---|
| 1 | DUDMA | 79.2 |
| | PEGDA700 | 19.8 |
| | AMA | 0.0 |
| | TPO-L | 1.0 |
| 2 | DUDMA | 75.2 |
| | PEGDA700 | 18.8 |
| | AMA | 5.0 |
| | TPO-L | 1.0 |
| 3 | DUDMA | 71.2 |
| | PEGDA700 | 17.8 |
| | AMA | 10.0 |
| | TPO-L | 1.0 |
| 4 | DUDMA | 63.2 |
| | PEGDA700 | 15.8 |
| | AMA | 20.0 |
| | TPO-L | 1.0 |
| 5 | DUDMA | 79.88 |
| | PEGDA700 | 19.97 |
| | 2-cyano-2-propyl benzodithioate | 0.10 |
| | TPO-L | 0.05 |

TABLE 2
Liquid Compositions for Grafting the Multifunctional
Material to the Base Object Using VAM.

| Index | Material | wt % | Base Object |
|---|---|---|---|
| A | MPA | 99.95 | 3D printed polymer with and without |
| | TPO-L | 0.05 | allyl functional moieties (Table 1 |
| | | | index 1-4) |
| B | CEA | 85.2 | 3D printed polymer with and without |
| | benzophenone | 14.8 | allyl functional moieties (Table 1 |
| | | | index 1-4) |
| C | CEA | 65.25 | Glass with TMSPMA primer material |
| | HEMA | 28.15 | |
| | PEGDA575 | 5.00 | |
| | MDEA | 1.60 | |
| | TPO-L | 0.05 | |
| D | CEA | 99.92 | Glass with TMSPMA primer material |
| | TPO-L | 0.08 | 3D printed polymer with RAFT agent |
| | | | (Table 1 index 5) |
| E | CEA | 70.23 | Glass with TMSPMA primer material |
| | HEMA | 29.71 | 3D printed polymer with RAFT agent |
| | TPO-L | 0.06 | (Table 1 index 5) |
| F | HEMA | 49.50 | Glass with TMSPMA primer material |
| | PEGDA 575 | 50.43 | 3D printed polymer with RAFT agent |
| | TPO-L | 0.07 | (Table 1 index 5) |
| G | CEA | 68.26 | 3D printed polymer with RAFT agent |
| | Acetonitrile | 31.63 | (Table 1 index 5) |
| | TPO-L | 0.11 | |
| H | CEA | 35.68 | 3D printed polymer with RAFT agent |
| | DUDMA | 14.28 | (Table 1 index 5) |
| | HEA | 35.68 | |
| | PEGDA 600 | 14.28 | |
| | TPO-L | 0.08 | |
| I | CEA | 69.15 | Glass with TMSPMA primer material |
| | HEMA | 29.10 | |
| | MDEA | 1.70 | |
| | TPO-L | 0.05 | |
| J | CEA | 2509 | Glass with TMSPMA primer material |
| | DUDMA | 692 | |
| | HDDA | 1594 | |
| | MDEA | 150 | |
| | TPO-L | 4.5 | |
| K | AgNO₃ | 4.34 | Glass with TMSPMA primer material |
| | CH₃CN | 14.29 | |
| | DUDMA | 48.48 | |
| | PEGDA 700 | 32.73 | |
| | TPO-L | 0.13 | |

### Addition of Primer Material to Base Object

A solution of 95% ethanol 5% water was adjusted to pH 4.5-5.5 by adding acetic acid. To this, TMSPMA was added while stirring to yield a 2% final concentration. After 5 minutes, borosilicate glass cylinders (20 mm height, 9 mm diameter) were dipped into the solution, agitated gently, and removed after 1-2 minutes. The cylinders were rinsed free of excess solution by briefly dipping in ethanol. The TMSPMA layer was cured for 24 h at room temperature.

### Printing

### Base Object:

For base objects that are 3D printed, an Asiga Max X27 digital light processing (DLP) printer was used. The resin vat of the printer was filled with about 50 g of the photoresin (Table 1). The following printing parameters were used to 3D print 10 mm cylinders with a height of 20 mm: layer height of 100 μm, light intensity of 25 mW/cm², exposure time of 1.5 s, and 385 nm light source. The cylinders were rinsed with isopropyl alcohol and dried with compressed air.

### Overprinting the Multifunctional Material:

An open top glass vial (nominal diameter 25 mm, measured diameter 24.8 mm, Kimble) was used for printing the multifunctional material. The multifunctional grafting liquid composition was allowed to warm to room temperature before printing. If any residual bubbles remained, the liquid composition was left to sit until the bubbles had disappeared. The vials were centered on a rotation stage (Physik™ Instrumente M-060.PD) with a custom designed vial holder. The position of the vial in the field of view of the projector was measured by sweeping a vertical line horizontally across the projector field and capturing the photo-initiator fluorescence with the camera. This alignment step is only completed once and does not need to be updated unless the system comes out of alignment. Projections were calculated and resampled according to the method described in Orth A, et al. On-the-fly 3D metrology of volumetric additive manufacturing. Feb. 7, 2022. DOI: 10.1016/j.addma.2022.102869.

### Without Primer Material, Immersed in Liquid Composition During Irradiation:

The base object was placed in a holder and inserted into a glass vial (FIG. 1). The vial was then slowly filled with the desired multifunctional grafting photoresin (Table 2) index A) until the cylinder is fully immersed and placed on the VAM stage for patterning. Samples were subjected to a pattern of two (inner diameter=8 mm, outer diameter=10 mm, height=1 mm, spacing=1 mm) or four vertically aligned discs (diameter=10 mm, height=1 mm, spacing=1 mm) using a 405 nm projector while the sample rotated on the stage. The following VAM parameters were used to graft the multifunctional material to the surface of the base object: light intensity of 2.8 or 6.4 mW/cm², rotation speed of 20°/s, and exposure time of 90-270 s (unless otherwise stated). The patterned cylinder was then removed from the vial, rinsed with copious amounts of ethanol and then subjected to vacuum curing with a relative pressure of less than −28 inHg in a FormLabs Form Cure™ L for 5 min.

### Without Primer Material, Placed in Inert Atmosphere During Irradiation:

The base object was placed in a holder and inserted into a glass vial. The vial was then slowly filled with the desired multifunctional material liquid composition (Table 2, index B) until the cylinder is fully immersed. Excess liquid composition was poured out of the vial, leaving a coating of the grafting photoresin on the surface of the cylinder. The vial was sealed with a rubber septum and two 18-gauge needles were inserted into the top of the septum: one for nitrogen gas flow and the other for venting the excess gas. With the needle supplying nitrogen inserted all the way to the bottom of the vial, the vessel was purged with nitrogen for 30 mins. Once complete, the needles were removed from the septum and the vial was placed in the stage for patterning. Samples were subjected to a pattern of four vertically aligned discs (diameter=10 mm, height=1 mm, spacing=1 mm) using a 405 nm projector while the sample rotated on the stage. The following VAM parameters were used to graft the multifunctional material to the surface of the base object: light intensity of 6.4 mW/cm², rotation speed of 20°/s, and exposure time of 540 s. The patterned cylinder was then removed from the vial, rinsed with copious amounts of ethanol and then subjected to vacuum curing with a relative pressure of less than −28 inHg in a FormLabs Form Cure™ L for 5 min.

### With Primer Material, Immersed in Liquid Composition During Irradiation:

The base object was placed in a holder and inserted into a glass vial. The vial was then slowly filled with the desired multifunctional grafting photoresin (Table 2, index C-F, I, and J) until the cylinder is fully immersed. The vial was then placed on the VAM stage for patterning. Samples were subjected to a pattern of two vertically aligned rings (inner diameter=8 mm, outer diameter=10 mm, height=1 mm, spacing=1 mm) using a 405 nm projector while the sample rotated on the stage. The following VAM parameters were used to graft the multifunctional material to the surface of the base object: light intensity of 2.8 mW/cm², rotation speed of 20°/s, and exposure time of 234 s. The patterned cylinder was then removed from the vial, rinsed with ethanol, and dried with compressed air. The pattern was further post-cured with an LED for 60 min.

### Coating Material Procedures

### Silver Layer:

A 0.1 M solution of silver nitrate in deionized water was prepared and vortex mixed for 1 min. The pH was adjusted to 11 by pipetting dropwise concentrated ammonia solution and vortexing to mix in between measurements with pH paper. The cylinders grafted with a carboxylate multifunctional material (Table 2, index A-B) were submerged in the silver seed solution for 5 min. The cylinder was removed, rinsed with copious amounts of ethanol, and left to air dry.

### Copper Layer:

The copper plating solution was prepared with 3 g of copper (II) sulfate pentahydrate, 14 g of sodium potassium tartrate tetrahydrate, 4 g of sodium hydroxide, and 100 mL of deionized water. The copper solution was mixed with 1.5 mL of formaldehyde to form the electroless plating solution. The silver patterned cylinder was submerged in the copper electroless plating solution for 10-30 min. Once complete, the sample was removed, rinsed with copious amounts of water, and left to air dry.

### Example 1: Grafting with 3-Mercaptopropionic Acid and Coating Materials

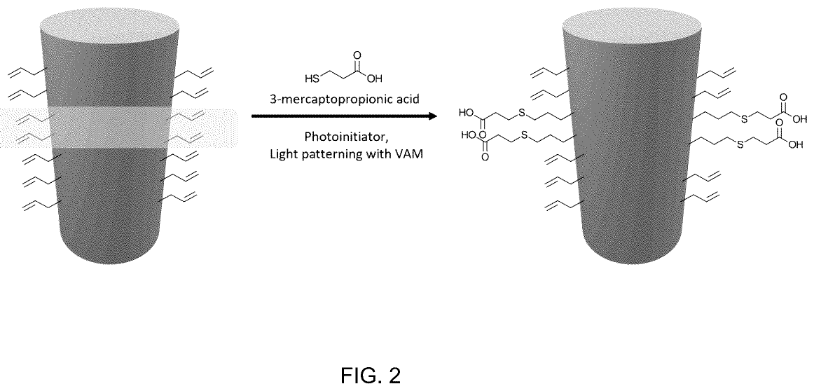

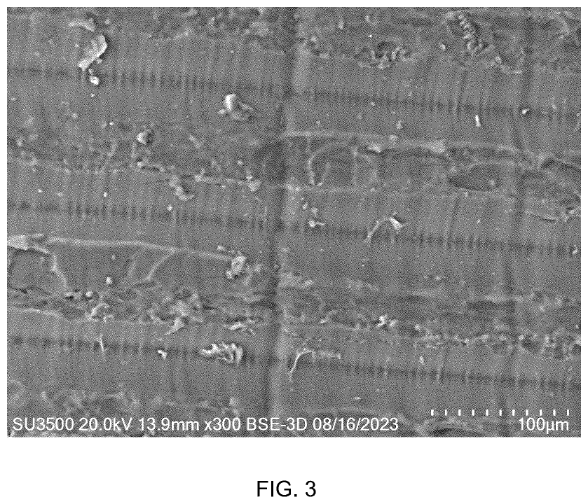

Allyl methacrylate was incorporated into the 3D printed base object in order to provide free allyl groups as the functional moiety to enable grafting (FIG. 2). Cylinders with various amounts of allyl methacrylate were 3D printed using conventional vat photopolymerization techniques (Digital Light Processing, DLP). The cylinders were then submersed in the multifunctional grafting photoresin consisting of 3-mercaptopropionic acid. The thiol group of the 3-mercaptopropionic acid reacts with the free allyl group of the allyl methacrylate in the base object in the presence of a photo-initiator (TPO-L) and light exposure to undergo a thiol-ene click reaction. Volumetric additive manufacturing was used to spatially pattern the light exposure and, thus, the grafting of a monolayer of 3-mercaptopropionic acid to the cylinder base object. The grafting and presence of the 3-mercaptopropionic acid was characterized with scanning electron microscopy (SEM) and energy dispersive X-ray spectroscopy (EDX) onto base objects 3D printed with 20 wt % allyl methacrylate (FIG. 3, Table 3). The presence of 3 bands of different morphology can be seen on the surface of the cylinder in the SEM image with the height matching the 1 mm height of the projected disc pattern. EDX mapping within these bands revealed 2.3 wt % sulfur, indicating the grafting of the 3-mercaptopropionic acid to the allyl groups on the cylinder base object.

TABLE 3
Elemental Composition Using Energy Dispersive X-ray Spectroscopy
(EDX) of a Cylinder with Grafted 3-Mercaptopropionic Acid.

| Element | wt % |
|---|---|
| C | 61.6 |
| O | 36.2 |
| S | 2.3 |

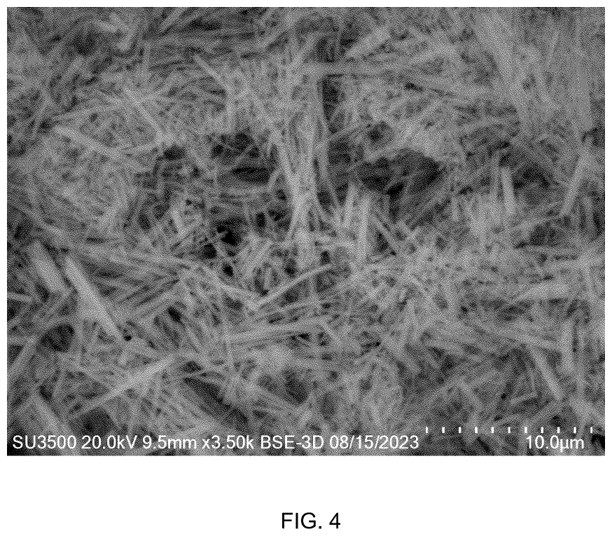

To further confirm the spatial patterning of the grafted 3-mercaptopropionic acid, a secondary step of adding a coating material was used whereby metal nanoparticles were bonded to the free carboxylic acid group of the 3-mercaptopropionic acid. In this case, a silver nitrate solution was used. SEM-EDX revealed regions of crystal formation with 62.0 wt % silver and 8.5 wt % sulfur (FIG. 4, Table 4). The silver coating material was also visually observed by dark brown rings forming in the regions that were patterned with the 3-mercaptopropionic acid and other unpatterned regions remaining unchanged in appearance.

TABLE 4
Elemental Composition Using Energy Dispersive X-
ray Spectroscopy (EDX) of a Cylinder with Grafted
3-Mercaptopropionic Acid and Silver Layer.

| Element | wt % |
|---|---|
| C | 15.7 |
| O | 13.7 |
| S | 8.5 |
| Ag | 62.0 |

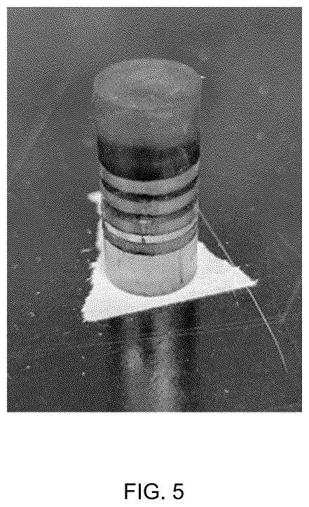

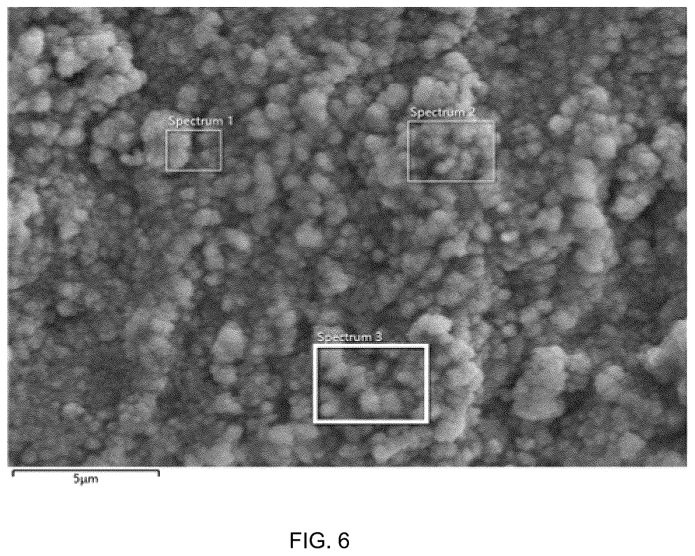

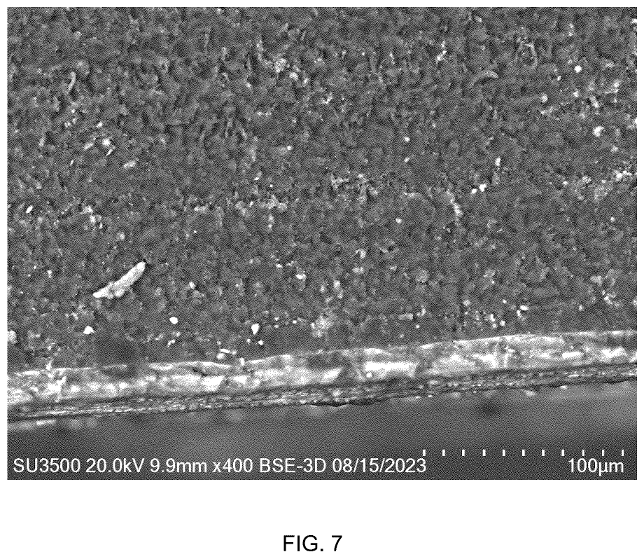

A subsequent copper layer was added by electroless plating to improve conductivity. Again, the copper only deposited where the 3-mercaptopropionic acid was patterned and the silver was deposited (FIG. 5). SEM-EDX measurements revealed 77.22 wt % copper, 8.10 wt % silver, and 1.10 wt % sulfur in the region of copper deposition (FIG. 6, Table 5). SEM images of the cross-section of the VAM grafted cylinder show a patterned and coating thickness of about 20 μm (FIG. 7).

TABLE 5
Elemental Composition Using Energy Dispersive X-ray
Spectroscopy (EDX) of a Cylinder with Grafted
3-Mercaptopropionic Acid, Silver Layer, and Copper Layer.

| Element | wt % |
|---|---|
| C | 7.88 |
| O | 5.70 |
| S | 1.10 |
| Ag | 8.10 |
| Cu | 77.22 |

The conductivity of the VAM patterned and coated traces on the cylinder samples were evaluated as a function of wt % allyl methacrylate incorporated into the 3D printed base object as well as the light dose used to VAM pattern the 3-mercaptopropionic acid layer (Table 6). Both low light dose (576 mJ/cm²) and 0-5 wt % allyl methacrylate in the base object resulted in no sign of metal deposition, non-conductive traces, or very poor conductivity (MΩ). Only light exposure of 1728 mJ/cm² and 20 wt % allyl methacrylate in the base object resulted in high conductivity (2-3Ω). Base object cylinders with 10 wt % allyl methacrylate only had high conductivity upon copper deposition. Overall, VAM was able to pattern 3-mercaptopropionic acid onto the surface of the base object, but to produce conductive traces with a metal coating layer, higher amounts of graftable groups on the base object and higher light dose exposure during VAM patterning is required to ensure enough grafting of the 3-mercaptopropionic acid occurs and provide available carboxylic acid groups for further functionalization.

TABLE 6
Linear Resistance Measurements of the Metal Bands
(1 mm in Width) Around Cylinders (1 cm in Diameter Grafted
with 3-Mercaptopropionic Acid) Coated with Silver and Copper as a
Function of wt % Allyl Methacrylate in Base Object and Grafting Light
Dose.

| VAM | | | | | |
|---|---|---|---|---|---|
| Printing | | | | | |
| Light Dose | | | | | |
| for | | | | | |
| Grafting | Coating | Wt % Allyl Methacrylate (wt %) | | | |
| (mJ/cm²) | Material | 0 | 5 | 10 | 20 |
| 576 | Silver | — | — | — | Not conductive |
| | Copper | — | — | — | MΩ |
| 1152 | Silver | Not | Not | Not | Not |
| | | conductive | conductive | conductive | conductive |
| | Copper | MΩ | MΩ | MΩ | kΩ-MΩ |
| 1728 | Silver | Not | MΩ | MΩ | 100-1500 |
| | | conductive | | | Ohms |
| | Copper | MΩ | MΩ | 1-3 Ω | 2-3 Ω |

### Example 2: Grafting with 2-Carboxyethyl Acrylate and Coating Materials

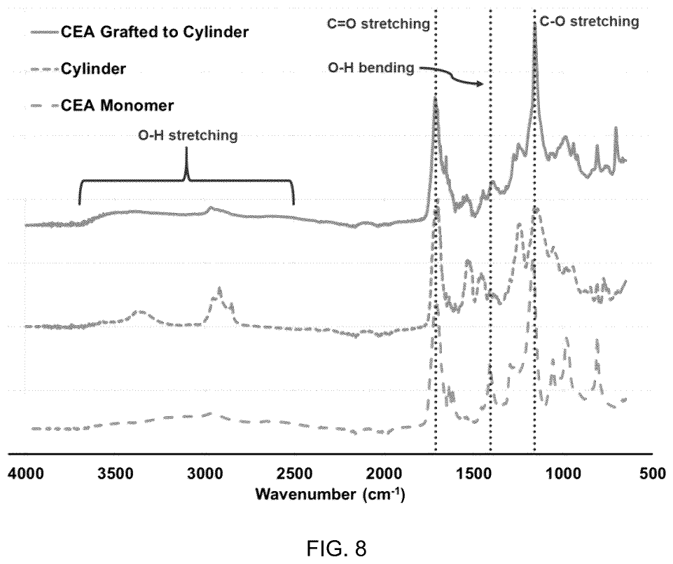

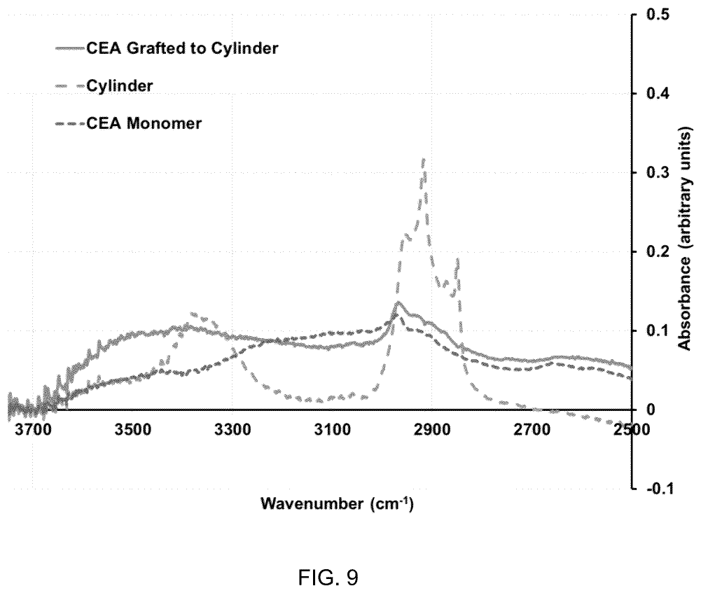

In addition to VAM patterning via thiol-ene click chemistry to graft a multifunctional material to the surface of the base object, VAM patterning was performed with acrylate radical polymerization of 2-carboxyethyl acrylate. To promote photopolymerization and prevent oxygen inhibition that occurs with acrylate radical polymerization, the base object was removed from the 2-carboxyethyl acrylate photoresin and placed in an inert nitrogen atmosphere during VAM patterning. Polymer rings of 2-carboxyethyl acrylate were successfully patterned onto base objects containing 0 and 20 wt % allyl methacrylate (Table 2 index B). The grafting of the acrylate group in 2-carboxyethyl acrylate to the allyl and/or acrylate groups in the base object were confirmed with Fourier transform infrared spectroscopy (FTIR) (FIG. 8). With 20 wt % allyl methacrylate incorporated into the 3D printed base object, the grafting of 2-carboxyethyl acrylate was observed by an increase in the peaks at 1160 cm⁻¹ and 1406 cm⁻¹, corresponding to C—O stretching and O—H bending of the carboxylic acid group, for the sample grafted with 2-carboxyethyl acrylate compared to the cylinder without grafting (when the spectrum were normalized to the C═O bond peak and baseline constant value). As well, the O—H stretching region at about 2500-3600 cm 1 becomes more pronounced with the grafted sample, indicating the presence of the patterned 2-carboxyethyl acrylate (FIG. 9).

### Example 3: Glass Base Object with Primer Material and Grafting with Acrylates

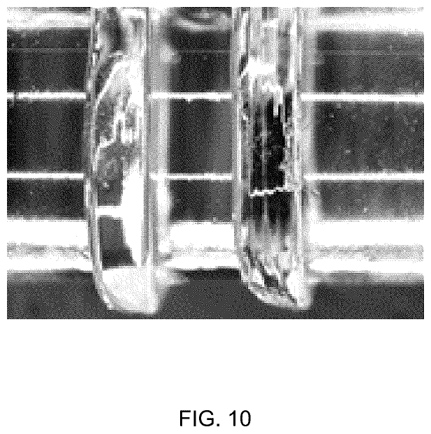

Multifunctional materials can also be grafted using VAM to non-3D printed base objects, such as glass. First, the surface of the glass is functionalized with a primer material, such as 3-(trimethoxysilyl) propyl methacrylate (TMSPMA), to provide a functional moiety that is covalently graftable. The silanization of TMSPMA to the surface of the glass through covalent bonding provides additional handles, a pendant methacrylate group, for photopolymerization patterning with VAM. After silanization of the glass cylinder, it is then placed in the VAM printer with an acrylate mixture photoresin (liquid composition) and patterned with light to form two rings of acrylate polymer through radical polymerization and grafting of the acrylates to the pendent acrylate moiety from TMSPMA on the glass cylinder surface. Multiple different acrylate-based liquid compositions were found to be successful with this approach (Table 2 index C-F, I, and J). The formation of these polymer rings can be visually seen (FIG. 10).

### Example 4: Grafting with Acrylates onto 3D Printed Base Object with RAFT Agent

Grafting of acrylates with VAM was also shown to be feasible onto 3D printed base objects containing a reversible addition-fragmentation chain-transfer (RAFT) agent. A RAFT agent, such as 2-cyano-2-propyl benzodithioate, aided in the grafting of acrylates to a 3D printed cylinder. Multiple different liquid compositions were found to successfully graft polymer rings around the base object containing the RAFT agent (Table 2 indices D-H). Covalent bonding of the acrylate to the 3D printed base object without a RAFT agent produced overprinted polymer rings with poor adhesion to the base object.

### Example 5: Grafting with Acrylates and Metal Salt Photoresin Mixture onto 3D Printed Base Object

Incorporating metal salts into the multifunctional material for grafting can add additional functionality to the patterned surface without the additional step of adding a coating material. Overprinted polymer rings using photoresin index J containing silver nitrate (Table 2) were grafted to a glass base object with TMSPMA primer material. Following copper electroless plating, the patterned features became conductive with point-to-point resistance for half the ring of 5Ω. The conductive features are characterized by energy dispersive X-ray spectroscopy (EDX) that indicates approximately 1:1 Ag:Cu film formed on the surface of the overprinted pattern (Table 7)

TABLE 7
Elemental Composition Using Energy Dispersive X-ray
Spectroscopy (EDX) of copper and silver coating layers
of the ring overprinted on glass cylinder with TMSPMA
primer, using liquid composition index K of Table 2.

| Element | wt % |
|---|---|
| O | 31.47 |
| Cu | 32.59 |
| Ag | 35.95 |

### Example 6: Patterned Overprinting of Crosslinkable Liquid Composition onto Various Base Objects

### Materials

### Materials Used for Base Object:

Polymethyl methacrylate (PMMA);
Polyoxymethylene (POM);
Borosilicate glass

### Multifunctional Materials in Liquid Composition:

2-carboxyethyl acrylate (CEA, Sigma-Aldrich);
Diurethane dimethacrylate (DUDMA, about 8,000-10,000 cP, Esstech, Inc.);
Poly(ethylene glycol) diacrylate (Mn 575 g/mol, PEGDA 575, Sigma-Aldrich);
Acrylic acid (AA, Sigma-Aldrich);
1,6-hexanediol diacrylate (HDDA, Alfa Aesar);
2-hydroxyethyl methacrylate (HEMA, Sigma-Aldrich)

### Additives:

N-methyldiethanolamine (MDEA, Sigma-Aldrich)

### Photo-Initiators:

Ethyl (2,4,6-trimethylbenzoyl)phenyl phospinate (TPO-L, Oakwood Products, Inc.)

### Results

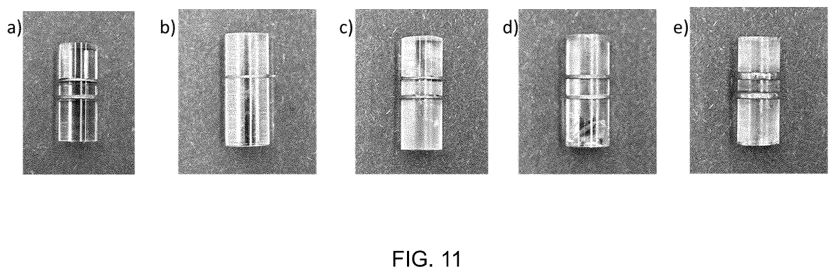

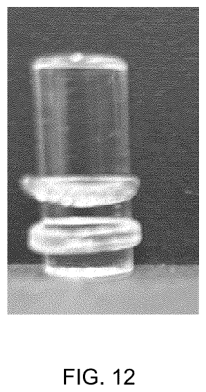

To provide better adhesion of the patterned overprinted multifunctional material to the base object, crosslinkers, such as DUDMA, HDDA, and PEGDA, were added to the liquid composition. This enabled overprinting onto other base objects such as PMMA and POM (Table 8). The 2-carboxyethyl acrylate (Table 8 index A-C, E-G) or acrylic acid (Table 8 index D) multifunctional materials in the liquid composition provided a handle to react a silver salt with the pendant carboxylic acid group, followed by copper electroless deposition to form a conductive coating layer. Liquid composition index D (Table 8) was overprinted and patterned onto PMMA and resulted in a conductive coating with point-to-point resistance for half the ring of 2-11Ω (FIG. 11). Table 9 shows elemental composition using energy dispersive X-ray spectroscopy (EDX) of copper and silver coating layers of the sample shown in FIG. 11c). Liquid composition index E was also overprinted and patterned onto PMMA in 2 rings (FIG. 12).

TABLE 8
Liquid Compositions for Overprinting the Multifunctional
Material to the Base Object Using VAM.

| Index | Material | Concentration (mM) | Base Object |
|---|---|---|---|
| A | CEA | 2509 | PMMA, POM |
| | DUDMA | 692 | |
| | HDDA | 1594 | |
| | MDEA | 150 | |
| | TPO-L | 4.5 | |
| B | CEA | 2486 | PMMA |
| | DUDMA | 506 | |
| | HDDA | 2102 | |
| | MDEA | 149 | |
| | TPO-L | 4.6 | |
| C | CEA | 3947 | PMMA, POM |
| | DUDMA | 1209 | |
| | MDEA | 155 | |
| | TPO-L | 4.4 | |
| D | AA | 4794 | PMMA |
| | DUDMA | 734 | |
| | HDDA | 1524 | |
| | MDEA | 144 | |
| | TPO-L | 4.6 | |
| E | CEA | 5660 | PMMA |
| | PEGDA 575 | 603 | |
| | MDEA | 156 | |
| | TPO-L | 2 | |
| F | CEA | 3977 | PMMA |
| | PEGDA 575 | 993 | |
| | MDEA | 153 | |
| | TPO-L | 2 | |
| G | CEA | 5499 | PMMA |
| | PEGDA 575 | 239 | |
| | HEMA | 1788 | |
| | MDEA | 62 | |
| | TPO-L | 2 | |

TABLE 9
Elemental Composition Using Energy Dispersive X-ray
Spectroscopy (EDX) of copper and silver coating layers of
the ring overprinted on PMMA cylinder from the sample
shown in FIG. 11c), using liquid composition index D of Table 8.

| Element | Wt % |
|---|---|
| K | 0.32 |
| Cu | 89.68 |
| Ag | 10.00 |

### Example 7: Overprinting

Before overprinting, liquid compositions may be decanted into open top glass vials used for printing (nominal diameter 25 mm, measured diameter 24.8 mm, Kimble) and may be allowed to warm to room temperature. A pre-printed solid base object may be then immersed in the liquid composition. If any residual bubbles remain, the liquid composition may be left to sit until the bubbles disappear.

The vials may be centered on a rotation stage (Physik™ Instrumente M-060.PD) with a custom designed vial holder. The position of the vial in the field of view of the projector may be measured by sweeping a vertical line horizontally across the projector field and capturing the photo-initiator fluorescence with the camera. This alignment step need only be completed once and does not need to be updated unless the system comes out of alignment.

Projections may be calculated and resampled according to the method described in Orth A, et al. On-the-fly 3D metrology of volumetric additive manufacturing. Feb. 7, 2022. DOI:10.1016/j.addma.2022.102869 (https://arxiv.org/abs/2202.04644).

Micro prints may be created with a digital light innovations CEL5500 light engine, with a 405 nm LED source. The projection lens may be replaced with two 75 mm focal length, plano-convex lenses (Thorlabs™ #LA1608) and an adjustable iris in a 4F arrangement, resulting in a telecentric projected image with pixel size of about 10.8 μm. At the projector focus distance may be located an 8 mm outer-diameter vial mounted to the rotation stage (PI Instruments). Rotation rates may be adjustable but may be normally set at 60 degrees/second. An optical scattering tomography (OST) system may be implemented, with a red LED source mounted vertically above the vial, and a FLIR camera mounted perpendicular to both the projector and LED light. All prints may be performed at room temperature, with typical projector irradiance values of 7 to 10 mW/cm².

### Post-Processing

Finished prints may be removed from the vial with a metal spatula and placed immediately in a dish filled with ethanol or isopropyl alcohol. The print may be left to soak a selected period of time (usually 10-20 minutes but depending on the liquid composition and print size) and then may be removed and left to dry at room temperature. Prints may be subsequently post-cured using 405 nm light for a selected period of time at selected temperature (e.g., 1 minute or less at 60° C.) in a Formlabs™ Form Cure curing box.

### Example 7A: Surface Grafting of Poly(Acrylic Acid)

### One-Step Process

A 10 wt % acrylic acid solution may be prepared using tert-butanol together with 0.01 wt % of isopropylthioxanthone. A pre-printed acrylate polymer cylinder may then be submerged in the aforementioned solution and subjected to 405 nm radiation (22.5 mW/cm²) for a designated amount of time to graft poly(acrylic acid) at selected locations using a tomographic printing system as described above. The surface-patterned print may then be washed with ethanol and air dried, followed by post curing.

### Two-Step Process

A printed acrylate polymer cylinder may be first submerged in a 10 wt. % solution of isopropylthioxanthone in ethanol for 5 minutes. The sample may then be rinsed twice with ethanol, air dried, then submerged in a 10 wt % acrylic acid solution in deionized water. The isopropylthioxanthone-treated print may then be subjected to 405 nm radiation (22.5 mW/cm²) using a tomographic printing system as described above to initiate grating of poly(acrylic acid) for a designed amount of time to achieve surface patterning at desired locations. The print may then be washed with ethanol and air dried, followed by post curing.

### Example 7B: Surface Grafting of Polyacrylamide

A preprinted acrylate polymer rod may be immersed in the benzophenone solution (10 wt % in ethanol) for 10 mins at room temperature, then washed with ethanol three times and air dried. The benzophenone-treated part may be submerged in an aqueous solution with 5 to 40 wt % acrylamide and 0.2 wt % lithium phenyl-2,4,6-trimethylbenzoylphosphinate. A tomographic printer with 405 nm light source may then be used as described above to initiate the grafting reaction at selected locations. When the grafting reaction is completed, the surface-patterned part may be rinsed in water and air dried, followed by post curing.

### Example 7C: Gold Surface Patterning

To prepare a surface with gold patterning, the surface may first be patterned by grafting carboxylic acid (COOH) groups (i.e., Example 7A). The surface-functionalized parts may then be immersed in a suspension of gold nanoparticles prepared based on literature for 1-2 days to seed the acid-treated surfaces with gold nanoparticles (Gittins, D. I. & Caruso, F. Spontaneous Phase Transfer of Nanoparticulate Metals from Organic to Aqueous Media. Angew. Chem. Int. Ed. 40, 3001-3004 (2001), the entire contents of which is herein incorporated by reference.). The gold nanoparticles-seeded parts may be subsequently washed with deionized water and then soaked in fresh deionized water for 1 day. This may be followed by electroless gold plating, where the seeded parts may be immersed in hydroxylamine hydrochloride (NH₂OH·HCl) aqueous solution with designed amounts of HAuCl₄·3H₂O added afterwards. After the reaction, the gold-coated part may be rinsed with deionized water multiple times, then soaked in fresh deionized water for 1 day, and subsequently air dried at room temperature.

### Example 7D: Patterned Metallization of an Acrylate-Grafted Solid Object

A solution may be prepared containing 4473 mM acetonitrile, 1384 mM PEGDA, 1069 mM DUDMA, 250 mM silver nitrate (AgNO₃) and 4.8 mM TPO-L. The components may be mixed to produce a colorless solution, which slightly turned to pale yellow after hours at room temperature. A printed polymethylmethacrylate (PMMA) cylinder may be submerged in the solution in a VAM vial and subjected to 405 nm radiation (22.5 mW/cm²) for a designated amount of time to graft the PEGDA and DUDMA containing Ag⁺ ions at selected locations using a tomographic printing system as described above. The overprinted object may then be washed in ethanol, followed by post curing.

The post-cured overprinted cylinder may be subjected to a direct copper electroless plating (EPL) process for 15 minutes at room temperature to produce an overprinted object having copper metal coated at the selected locations on the cylinder, without the need to reduce Ag⁺ ions into Ag⁰ seeds.

The same procedure as described above may be used to selectively overprint and metallize a cylinder of glass having a primer coating of 3-(trimethoxysilyl) propyl methacrylate (TMSPMA) grafted thereon.

### Example 8: Overprinting Using the Dry Process

### Preparation of Liquid Photoresin Composition

Photoresins were prepared by placing all the components of the formulations in a plastic container. The mixture was then mixed with a plenary mixer (Thinky ARE-310) for 3 minutes to give a homogenous clear liquid. The ink was stored under 5° C. with wrapped aluminium foil to minimized exposure to ambient light.

### Fabrication of Base Objects

Base objects in the shape of rods were printed with Form2 or Form 4 3D printers using Tough1500 resins from Formlabs™. The square rods had heights of 100 mm and 10 mm widths while the cylindrical rods had a diameter of 9.5 mm and height of 85 mm. After printing, the rods were soaked in isopropyl alcohol (IPA) for 10 min, rinsed with IPA and post cured with LED (70° C. for 60 min, Form cure).

### Coating and Patterning

The rods were dipped into a vial filled with photoresin and were slowly removed after being immersed for 30 seconds. After removing the excess photoresin that collected at the bottom of the rod, the rod was inserted into a holder, placed in an empty vial and left to stand for 5 min. The vial holding the coated rod was then illuminated with light patterns using a VAM printer (Wintech™).

### Metallization

Resins that contain functional groups that bind to metal salts can be metallized into conductive features. The functional polymer patterns on square rod surfaces were metallized by following steps:

(A). Silver cation exchange: The patterned rod was immersed in an aqueous solution that contains 0.1 M AgNO₃ and NH₄OH (pH 10.5-11) for 5 min to convert carboxylic acid functional groups to silver carboxylate groups. Once removed from the silver salt solution, the surface of the patterned rod was rinsed with distilled water.

(B). Copper electroless plating (Cu ELP): Cu ELP was carried out using a Caswell™ Cu ELP solution at 45° C. for 3 min or by using NRC Cu ELP solution (See Example 10) and operated at 40° C. for 5-10 min. After plating, the patterned rods were rinsed with distilled water and dried with air flow.

### Example 8A: Multiple Ring Patterns Printed and Cu Electroless Plated on a Cylindrical Rod

Photoresins were prepared with the formulations listed in Table 10 and following the methods described above.

TABLE 10
Photoresin Formulation Used for Example 8A

| Component | Weight (g) | % (w/w) | mM |
|---|---|---|---|
| DUDMA | 70.00 | 67.90 | 1623.39 |
| Acrylic acid | 30.00 | 29.10 | 4543.26 |
| TPO-L | 3.09 | 3.00 | 106.63 |
| Total | 103.09 | 100.00 | |

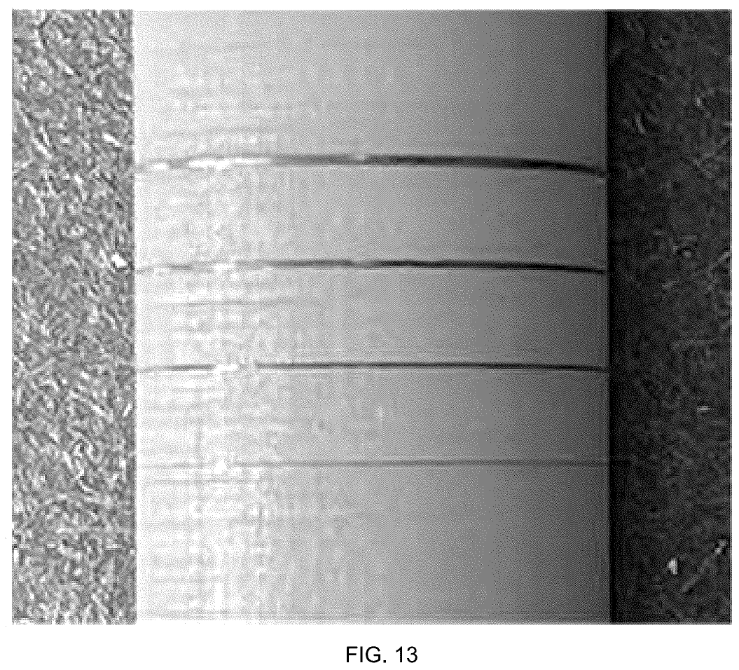

A volumetric additive manufacturing (VAM) printer built with a Wintech™ projector was used at a light Intensity of 19.18 mW/cm². The projection patterns comprised 4 disks that had heights of 46.5 μm, 93 μm, 139.5 μm and 186 μm and a spacing between each line of 1.86 mm. The printer was operated at a 40°/second rotation speed and completed one rotation in 9 seconds. The printed polymer patterns were cured in a Skyray™ 800 LED chamber for 30 s (388 mW/cm², 405 nm) post-VAM printing. To metallize the surface of the printed pattern, the rod was submerged into the silver salt solution at room temperature for 5 min and Cu ELP was carried out at 45° C. for 5 min with the Caswell solution. FIG. 13 shows the VAM patterned cylindrical rod with the ring features coated with copper.

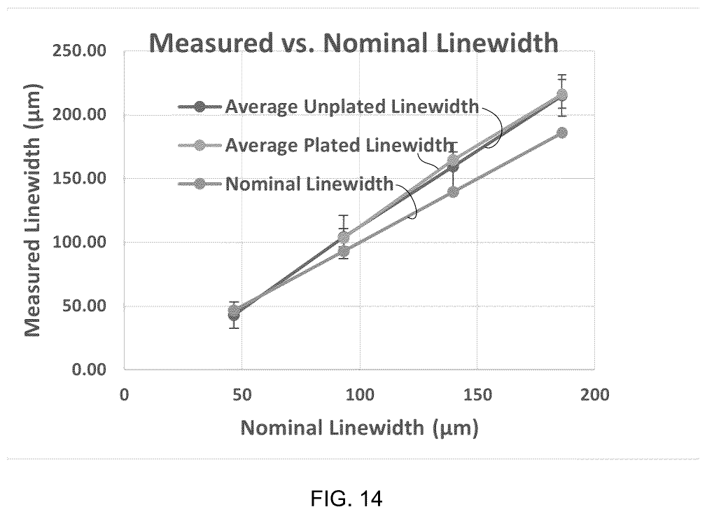

The linewidth and thickness of the printed patterns (rings) (see Table 11) were measured with a profilometer (CT100, Cyber™ Technologies). Using this approach, conductive copper lines with widths as low as 103 μm were generated. A copper plated ring feature with a linewidth of 47 μm was also formed, however, the resistance measurement is very difficult for a cyclic pattern, therefore sheet resistance was not recorded. FIG. 14 depicts a graph of measured linewidth (μm) vs. nominal linewidth (μm) for the copper coated rings on the cylindrical object shown in FIG. 13.

TABLE 11
Linewidth and Line Thickness for both Printed and Cu-plated Patterns

| | Ring 1 | Ring 2 | Ring 3 | Ring 4 |
|---|---|---|---|---|
| Nominal linewidth (μm) | 46.5 | 93 | 139.5 | 186 |
| Cu plated linewidth (μm) | 45.8 ± 1.7 | 103.5 ± 7.3 | 164.5 ± 6.2 | 216.3 ± 11.4 |
| Cu plated line thickness | 10.7 ± 2.2 | 18.5 ± 2.5 | 23.1 ± 5.9 | 22.8 ± 5.9 |
| (μm) | | | | |

### Example 8B: Coil Pattern Printed and Cu Electroless Plated on Cylindrical Rod

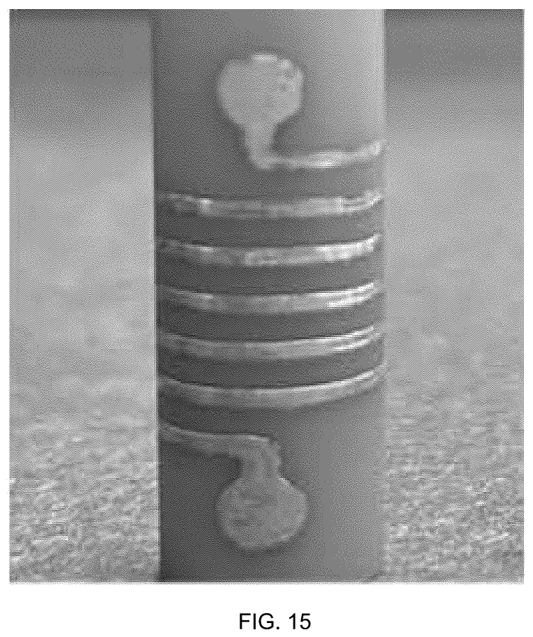

A photoresin with the formulation in Table 12 was prepared. Using a VAM printer with a Wintech™ projector, printing was carried out with light intensity of 37.2 mW/cm² with a ray tracing method. The light patterns generated a coil pattern of 150 mm length and 0.5 mm linewidth around a cylindrical rod. The printer was operated at a 40°/second rotation speed and completed three rotations in 27 seconds. The coil pattern was then metallized following the steps described above. The silver salt exchange was carried out at room temperature for 5 min with a Caswell Cu ELP operated at 45° C. for 5 min. The measured linewidth and the resistance were 849.2 μm and 7.6Ω, respectively, yielding a sheet resistance of 41 mΩ/□, based on a total length of 15.9 mm (see Table 13). FIG. 15 shows the patterned cylindrical rod with the coil feature coated with copper.

TABLE 12
Photoresin Formulation Used for Example 8B

| Component | Weight (g) | % (w/w) | mM |
|---|---|---|---|
| DUDMA | 80.000 | 78.40 | 1865.79 |
| Acrylic acid | 20.000 | 19.60 | 3045.96 |
| TPO-L | 2.0400 | 2.00 | 70.79 |
| Total | 102.0400 | 100.00 | |

TABLE 13
Linewidth, Thickness and Sheet Resistance for Cu-plated Patterns

| | Coil |
|---|---|
| Nominal linewidth (μm) | 750 |
| Cu plated linewidth (μm) | 849 ± 57 |
| Cu plated line thickness (μm) | 23.7 ± 2.5 |
| Sheet resistance (mQ/□) | 41 |

### Example 8C: Conductive Patterns Created on a Square Rod

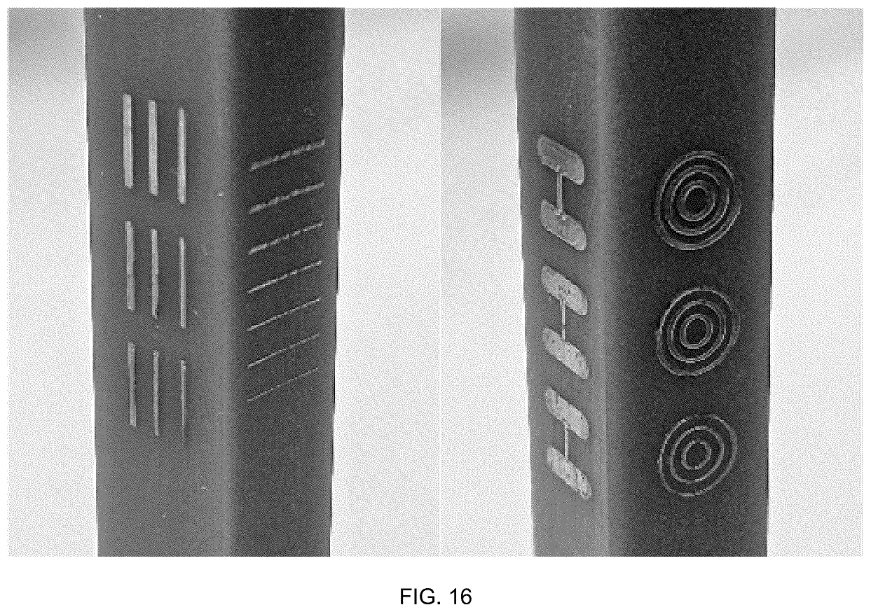

A photoresin was formulated according to Table 14. A VAM printer with a Wintech™ projector was used to print using varying light intensities during printing. The maximum intensity was 44.46 mW/cm². The projection pattern included four different patterns on each side of the rod. One side had 7 horizontal lines with linewidths varying from 50 μm to 350 μm. Another side had 9 vertical lines with linewidths that varied from 50 μm to 250 μm. Another side had 3 sets of concentric circles with linewidths that varied from 50 μm to 250 μm. The last side of the square rod had 3 vertical narrow lines, having linewidths varying from 50 μm to 250 μm, connected to electrical pads. The printer was operated at a 40/second rotation speed and completed one rotation in 9 seconds. The pattern was metallized following the steps described above. The silver salt exchange was carried out at room temperature for 5 min and Cu ELP was performed at 45° C. for 3 min. The linewidth and the resistance of the 9 vertical line pattern and outer circles of the concentric circles pattern were measured to calculate the sheet resistance. High conductive copper plated patterns had sheet resistances of approximately 100-350 mΩ/□ (see Table 15 and Table 16). FIG. 16 shows the sides of the square rod with the printed patterns coated with copper.

TABLE 14
Photoresin Formulation Used for Example 8C

| | Weight (g) | % (w/w) | nM |
|---|---|---|---|
| DUDMA | 42.61 | 56.65 | 1360.42 |
| Acrylic Acis | 21.30 | 28.32 | 4440.81 |
| Antofoam 204 | 0.0251 | 0.03 | NA |
| Ethyl Cellulose (46 cP) | 0.751 | 1.00 | NA |
| Di(propylene glycol) methyl ether* | 6.759 | 8.99 | 685.19 |
| TPO-L | 3.771 | 5.01 | 179.15 |
| Total | 75.2161 | 100.00 | |

*10% (w/w) EC in DPGME

TABLE 15
Linewidth and Sheet Resistance for Cu-plated 9 Vertical Line Pattern

| | Line 1 | Line 2 | Line 3 | Line 4 | Line 5 | Line 6 | Line 7 | Line 8 | Line 9 |
|---|---|---|---|---|---|---|---|---|---|
| R | 2.1 | 4.3 | 3.5 | 2.3 | 6.6 | 4.6 | 2.4 | 4.9 | 4.2 |
| LL | 5000 | 5000 | 5000 | 5000 | 5000 | 5000 | 5000 | 5000 | 5000 |
| LW | 420 | 460 | 410 | 480 | 380 | 370 | 450 | 300 | 330 |
| SR | 176.4 | 395.6 | 287 | 220.8 | 501.6 | 340.4 | 216 | 294 | 277.2 |

R: Resistance (Ω),
LL: Line length (μm),
LW: Linewidth (μm),
SR: Sheet resistance (mΩ/□)

TABLE 16
Linewidth and Sheet Resistance for Cu-plated Concentric Ring Pattern

| | OC1 (left) | OC2 (middle) | OC3 (right) |
|---|---|---|---|
| Resistance (Ω) | 3.2 | 4.0 | 2.8 |
| Line length (μm, half ring) | 7000 | 7000 | 7000 |
| Linewidth (μm) | 345.0 | 302.5 | 254.0 |
| Sheet resistance (mΩ/□) | 157.7 | 172.9 | 101.6 |

### Example 9: Photoresin Composition for an Oxygen-Containing Environment

Synthesis of [tOctNH₃][AMPS] Oxygen-Diffusion Inhibitor

To a stirred suspension of 10 g (48.3 mmol) of 2-acrylamido-2-methylpropane sulfonic acid (AMPS) in 50 mL of methanol was added dropwise 6.9 g (53.1 mmol) of tert-octylamine. The reaction mixture was allowed to stir for 10 minutes, then 50 mL of toluene was added. The solvents were then removed under high vacuum at 40° C. to obtain the product in quantitative yield. The acid-base reaction of tert-octylamine with 2-acrylamido-2-methylpropane sulfonic acid to form tert-octylammonium 2-acrylamido-2-methylpropane sulfonate is illustrated in Scheme 1.

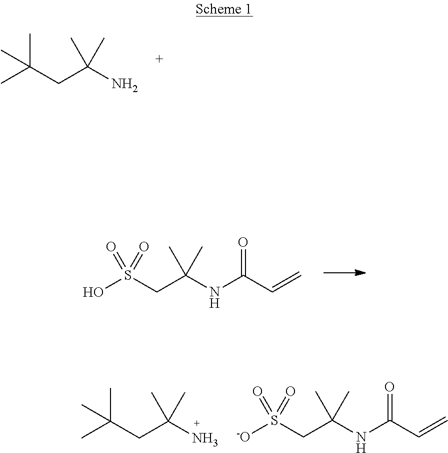

### Formulation of Photografting Resins

20 g of tert-octylammonium 2-acrylamido-2-methylpropane sulfonate ([tOctNH₃][AMPS]) and 400 mg of triphenylphosphine (TPP) were dissolved in 17.6 g of acrylic acid (AA). This stock solution was mixed with varying weight percentages of isopropylthioxanthone (ITX). The viscosities of these formulations are about 300 cP. A typical concentration used for ITX is 5 wt % (see Table 17).

TABLE 17
Benchmark Formulation for Photografting

| Compound | Function | Concentration (wt %) |
|---|---|---|
| Isopropylthioxanthone (ITX) | Norrish Type II | |
| | photo-initiator | |
| tert-octylammonium 2- | Oxygen-diffusion | |
| acrylamido-2-methylpropane | inhibitor | |
| sulfonate ([tOctNH₃][AMPS]) | | |
| Acrylic Acid | Reactive monomer | |
| Triphenylphosphine | Non-amine reducing | |
| | agent | |

### Example 9A: Photo-Patterning Lines on a PET Substrate

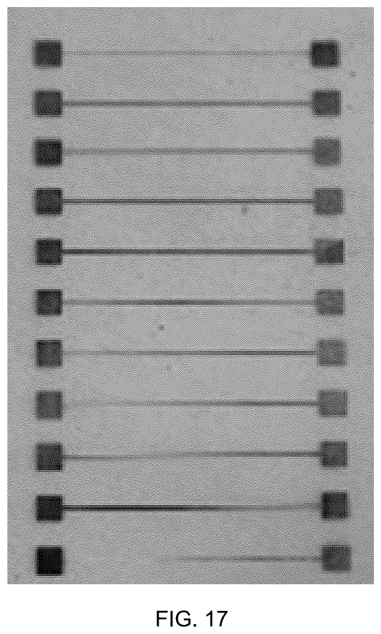

Patterns comprising (nominally) 2 cm long lines ranging from 40 μm to 200 μm in width were designed along with 2 mm×2 mm pads on both ends to act as electrical contacts. A representative formulation comprising 44 wt % acrylic acid, 50 wt % tert-octylammonium 2-acrylamido-2-methylpropane sulfonate, 5 wt % isopropylthioxanthone (mixture of 2- and 4-isomers) and 1 wt % triphenylphosphine was poured over top of a 4″×4″×0.005″ sheet of polyethylene terephthalate (PET). The PET sheet was then centered over the focal plane of a 405 nm DLP projector and the pattern was projected from underneath the PET at a light intensity of 100 mW/cm² for 30 s. The sample was then subjected to post processing and plating (see Example 10) to afford copper traces (FIG. 17). The dimensions of the copper traces were measured by optical profilometry and electrical resistances were measured across the lines using a multimeter. The volume resistivities of the lines were calculated based on the length, width and thickness of the plated copper. Results are shown in Table 18.

TABLE 18
Dimensions and Volume Resistivity of Selected
Copper Plated Traces

| Resistance | line length | linewidth | thickness | Resistivity |
|---|---|---|---|---|
| (Ω) | (μm) | (μm) | (μm) | (μΩcm) |
| 236.9 | 20,000 | 116 | 0.22 | 30.22 |
| 106.3 | 20,000 | 149 | 0.2 | 15.8 |
| 43.8 | 20,000 | 189 | 0.27 | 11.2 |
| 36.2 | 20,000 | 221 | 0.28 | 11.2 |
| 32.3 | 20,000 | 249 | 0.27 | 10.9 |
| 108.3 | 20,000 | 77 | 0.35 | 14.6 |
| 48.4 | 20,000 | 114 | 0.29 | 8.0 |
| 68.3 | 20,000 | 148 | 0.26 | 13.1 |
| 135.8 | 20,000 | 188 | 0.3 | 38.3 |
| 359.8 | 20,000 | 224 | 0.2 | 80.6 |
| NC* | 20,000 | 57 | 0.31 | — |
| 631 | 20,000 | 120 | 0.25 | 94.7 |
| 160 | 20,000 | 180 | 0.24 | 34.6 |
| 57.4 | 20,000 | 225 | 0.24 | 15.5 |
| 33.3 | 20,000 | 293 | 0.29 | 14.1 |

* = Not conductive

### Example 9B: Photo-Patterning at Different Light Intensity and Photo-Initiator Concentrations

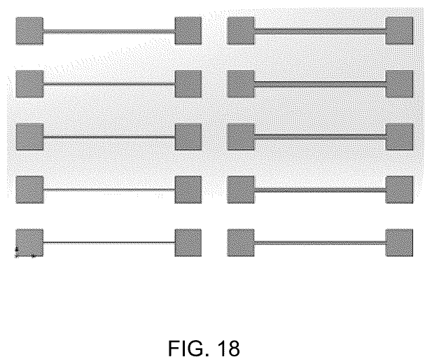

In order to probe the efficacy of this photografting at lower photoinitiator concentrations and at various light intensities, a qualitative assessment was performed with a new template with 1 cm lines ranging from 40 to 400 μm in width (FIG. 18). After copper plating (see Example 10) was complete, a visual inspection was performed to see if sufficient photografting occurred to realize copper plated features at various feature dimensions. ITX concentrations of 0.1 wt %, 1 wt %, 2 wt %, 3 wt %, 4 wt % and 5 wt % were employed and the minimum feature size that was observed to be copper plated was recorded (see Table 19).

TABLE 19
Minimum Feature Sizes for Photografted
Patterns for a Given Set of Conditions

| | | Concentration of ITX (wt %) | | | | | |
|---|---|---|---|---|---|---|---|
| | | 0.1 | 1 | 2 | 3 | 4 | 5 |
| Light | 28 | ~2 mm | 80 μm | 40 μm | 40 μm | 40 μm | 40 μm |
| intensity | 52 | ~2 mm | 40 μm | 40 μm | 40 μm | 40 μm | 40 μm |
| (mW/cm²) | 70 | ~2 mm | 40 μm | 40 μm | 40 μm | 40 μm | 40 μm |

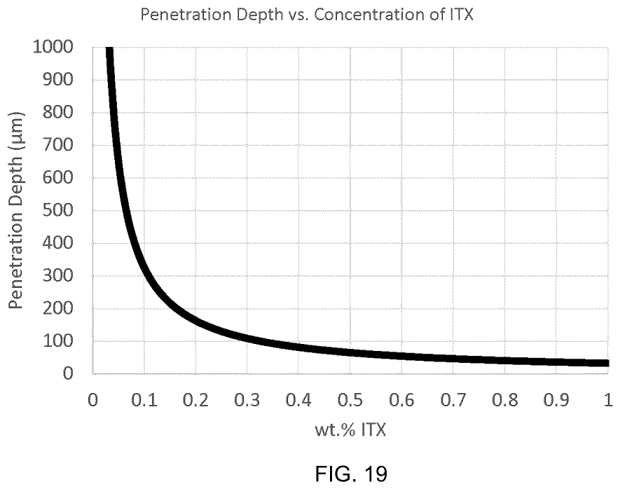

Due to the initiation of graft photopolymerization requiring the absorption of light, there are limitations to the depth of penetration of light. The light penetration depth is inversely related to the extinction coefficient of the photo-initiator as well as its concentration (see Table 20 and FIG. 19). This imposes a limitation on the concentration of the photo-initiator, or conversely the coating thickness.

TABLE 20
Penetration Depth as a Function of ITX Concentration

| ITX concentration (wt %) | Penetration Depth (μm) |
|---|---|
| 5 | 6.5 |
| 4 | 8.1 |
| 3 | 10.8 |
| 2 | 16.3 |
| 1 | 32.5 |
| 0.5 | 65.0 |
| 0.1 | 325.2 |

### Example 9C: Photo-Patterning on 3D Surfaces

To demonstrate that this technique can be applied to 3-dimensional surfaces, a formulation was developed where the substrate may be dip coated in the photografting formulation and then subjected to photo-patterning using a volumetric printer.

A 10 mm diameter rod composed of Nylon™ 6,6 was submerged in a formulation comprising 50 wt % [tOctNH₃][AMPS], 48 wt % acrylic acid, 1 wt % 2-tert-butylanthraquinone and 1 wt % triphenylphosphine. The rod was removed from the formulation, affixed with spacers and was then placed within a 24 mm diameter vial to keep the rod centered and vertically aligned. The vial was then centered on a rotational stage. Patterning was achieved by rotating the vial at a rotation speed of 1°/s and projecting the pattern at a wavelength of 405 nm and a light intensity of 20 mW/cm² for 2 rotations (total duration=12 min).

The rod was then removed from the printer and post processed in the same manner as the previous examples (see Example 10), affording copper traces on the photo-patterned rod.

### Example 9D: Photo-Patterning with 1-Vinyl-3-Alkylimidazolium Salts as Reactive Monomer

It was found that 1-vinyl-3-alkylimidazolium salts can also act as functional monomers for electroless plating through the formation of silver (I) carbene complexes upon exposure to 0.1 M diamminesilver(I) nitrate (see Scheme 2). Scheme 2 illustrates the free radical polymerization of a vinylimidazolium cation (A) and subsequent N-heterocyclic carbene formation by treatment with diamminesilver(I) nitrate (B). A representative formulation comprising 50 wt % 1-tert-butyl-3-vinylimidazolium acrylate, 44 wt % 1-tert-butyl-3-vinylimidazolium 2-acrylamido-2-methylpropane sulfonate, 5 wt % isopropylthioxanthone (mixture of 2- and 4-isomers) and 1 wt % triphenylphosphine was poured over top of a 4″×4″×0.005″ sheet of PET. The PET sheet was then centered over the focal plane of a 405 nm DLP projector and the pattern was projected from underneath the PET at a light intensity of 100 mW/cm² for 30 s. The sample was then subjected to the same post processing and plating protocols outlined earlier to afford copper traces.

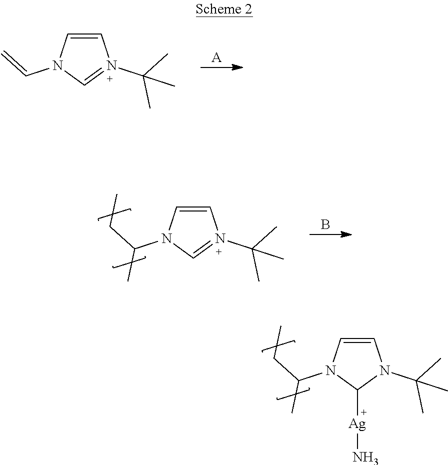

### Example 10: Copper Plating Protocol

### Priming the Grafted Substrates for Copper Plating

Grafted substrates were submerged in a 0.1 M diamminesilver(I) nitrate solution for 5 minutes. This step forms silver (I) complexes with the grafted polymer which acts as a catalyst for the deposition of copper during electroless plating. The substrates were then removed from the solution and rinsed with copious amounts of water and air dried.

### Preparation of Solution A

1. Add 1,500 mL Milli-Q™ water and a PTFE stir bar to a 2 L glass bottle equipped with a lid.
2. Secure the bottle on a stir plate and set the stirring speed between low and medium.
3. Gradually add 4 5 g of Copper (II) Sulfate, 210 g Sodium Potassium Tartrate, and 60 g Potassium Hydroxide to the bottle.
4. Stir until all solids are dissolved.

### Preparation of 2,2′-Bipyridyl Solution

1. Dissolve 0.4 mg 2,2′-Bipyridyl in 1 g ethanol.

### Preparation of Final Copper Plating Solution

1. Add 2,000 mL Milli-Q™ water to a 5 L glass bottle equipped with a lid.
2. In a glass vial, measure 26.6 mg SDS, 54 mg NiSO₄·6H₂O, 18 mg TEA, and 3.63 mg of the 2,2′-Bipyridyl solution.
3. Add approximately 5 mL of the 2,000 mL Milli-Q™ water to the glass vial. Sonicate the solution so that all solids are dissolved.
4. Pour the contents of the glass vial into the 5 L glass bottle.
5. Add 1,000 mL Solution A to the 5 L glass bottle.

### Copper Plating Samples

1. Add enough copper plating solution to a plastic or glass container so that the entire sample can be fully submerged.
2. Heat the copper plating solution in the plastic or glass container to 40° C. using a
water bath.

3. Add a 1:30 formaldehyde:copper plating solution to the copper plating solution. Stir the solution with a glass stir rod. (The amount of formaldehyde added may need to be adjusted. This is the ratio that has been used).
4. Gently wipe the traces of the sample with an isopropyl alcohol wipe. Let the sample dry.
5. Submerge the sample in the copper plating solution for 5 minutes.
6. Remove the sample and place the sample in a Milli-Q™ water bath. Use Milli-Q™ water to rinse any excess copper plating solution.

The novel features will become apparent to those of skill in the art upon examination of the description. It should be understood, however, that the scope of the claims should not be limited by the embodiments but should be given the broadest interpretation consistent with the wording of the claims and the specification as a whole.

1. A photoresin composition for photopatterning in an oxygen-containing environment, the composition having a viscosity of about 300 cP or higher and comprising:
a reactive monomer with no hydrogen atoms having a bond-dissociation energy of less than about 410 kJ/mol;
a non-amine reducing agent; and,
a Norrish Type II photo-initiator.

2. The composition of claim 1, wherein:
(a) the reactive monomer comprises acrylic acid, 2-acrylamido-2-methylpropane sulfonic acid, sodium 2-acrylamido-2-methylpropane sulfonate, vinylsulfonic acid, sodium vinylsulfonate, ammonium vinylsulfonate, vinyl phosphonic acid, sodium vinyl phosphonate, ammonium vinyl phosphonate, 4-styrenesulfonic acid, sodium 4-styrenesulfonate, or any mixture thereof;
(b) the non-amine reducing agent comprises triphenylphosphine, tris(o-tolyl)phosphine, 3,3′,3″-phosphanetriyltris(benzenesulfonic acid) trisodium salt, 3,3′,3″-phosphanetriyltris(benzenesulfonic acid) trisodium salt, triphenylphosphite, tris(2,4-di-tert-butylphenyl) phosphite, ethyldiphenylphosphinite, methyldiphenylphosphinite, or any mixture thereof;
(c) the Norrish Type II photo-initiator comprises 2-isopropylthioxanthone, 4-isopropylthioxanthone, 2-chlorothioxanthone, benzophenone, 4-chlorobenzophenone, 4,4′-dichlorobenzophenone, xanthone, anthraquinone, 2-methylanthraquinone, 2-tert-butylanthraquinone, 9-fluorenone, camphorquinone, or any mixture thereof; or,
(d) any combination of (a) to (c).

3. The composition of claim 1, wherein:
(i) the reactive monomer is present in the composition in an amount in a range of about 50-99 mol %;
(ii) the non-amine reducing agent is present in the composition in an amount in a range of about 4-200 mM;
(iii) the Norrish Type II photo-initiator is present in the composition in an amount in a range of about 0.1-10 mol %; or,
(iv) any combination of (i) to (iii).

4. The composition of claim 1, further comprising an oxygen-diffusion inhibitor with no hydrogen atoms having a bond-dissociation energy of less than about 410 kJ/mol, the oxygen-diffusion inhibitor inhibiting oxygen diffusion in the composition without lowering grafting efficiency to a surface of a solid object of a polymer formed from the reactive monomer.

5. The composition of claim 4, wherein the oxygen-diffusion inhibitor comprises 1-butyl-3-methylimidazolium chloride, 1-ethyl-3-methylimidazolium chloride, 1-butyl-1-methylpyrrolidinium chloride, N-butylpyridinium chloride, 1-butyl-3-methylimidazolium tetrafluoroborate, 1-ethyl-3-methylimidazolium tetrafluoroborate, 1-butyl-1-methylpyrrolidinium tetrafluoroborate, N-butylpyridinium tetrafluoroborate, 1-butyl-3-methylimidazolium hexafluorophosphate, 1-ethyl-3-methylimidazolium hexafluorophosphate, 1-butyl-1-methylpyrrolidinium hexafluorophosphate, N-butylpyridinium hexafluorophosphate, 1-butyl-3-methylimidazolium acrylate, 1-ethyl-3-methylimidazolium acrylate, 1-butyl-1-methylpyrrolidinium acrylate, N-butylpyridinium acrylate, 2-acrylamido-2-methylpropane sulfonic acid, sodium 2-acrylamido-2-methylpropane sulfonate, ammonium 2-acrylamido-2-methylpropane sulfonate tert-butylammonium 2-acrylamido-2-methylpropane sulfonate, tert-octylammonium 2-acrylamido-2-methylpropane sulfonate, 1-butyl-3-methylimidazolium 2-acrylamido-2-methylpropane sulfonate, 1-ethyl-3-methylimidazolium 2-acrylamido-2-methylpropane sulfonate, 1-butyl-1-methylpyrrolidinium 2-acrylamido-2-methylpropane sulfonate, N-butylpyridinium 2-acrylamido-2-methylpropane sulfonate, poly(tert-butyl methacrylate), poly(dimethyl siloxane), poly(α-methylstyrene), 1,3-di-tert-butyl imidazolium acrylate, 1,3-di-tert-butyl imidazolium 2-acrylamido-2-methylpropane sulfonate, N-tert-butyl pyridinium acrylate, N-tert-butyl pyridinium 2-acrylamido-2-methylpropane sulfonate, or any mixture thereof.

6. The composition of claim 1, wherein the photopatterning comprises volumetric additive manufacturing (VAM).

7. A volumetric additive manufacturing (VAM) process for producing a solid object having a surface layer of a multifunctional material patterned on the solid object, the process comprising:
immersing a solid base object in a liquid photoresin composition comprising a photo-initiator and a multifunctional material;
removing the solid base object from the liquid photoresin composition thereby providing the solid base object with a film coating of the liquid photoresin composition; and,
selectively irradiating the composition at the surface of the solid base object with patterned light to initiate covalent grafting or adhesion of the multifunctional material to the surface of the solid base object to pattern only a portion of the surface of the solid base object with a layer of the multifunctional material grafted or adhered thereon, where the portion of the surface of the solid base object corresponds to the selectively irradiated surface of the solid base object.

8. The process of claim 7, wherein the selectively irradiating comprises irradiating with the patterned light that is calculated and projected using tomographic imaging.

9. The process of claim 7, wherein the solid base object is placed in an oxygen-containing environment for irradiation after being removed from the liquid photoresin composition.

10. The process of claim 7, wherein the solid base object is placed in an inert environment for irradiation after being removed from the liquid photoresin composition.

11. The process of claim 7, wherein the film coating has a thickness in a range of about 10-5000 μm.

12. The process of claim 11, wherein the thickness is in a range of about 100-200 μm.

13. The process of claim 7, wherein the photo-initiator is in the liquid photoresin composition at a concentration in a range of 3-300 mM.

14. The process of claim 13, wherein the concentration of the photo-initiator is in a range of about 30-60 mM.

15. The process of claim 7, wherein the liquid photoresin composition has a viscosity in a range of about 1,000-2,000 cP.

16. The process of claim 7, wherein the patterned light has an intensity in a range of about 25-100 mW/cm².

17. The process of claim 7, wherein the selectively irradiating is performed for a time in a range of about 1-60 seconds.

18. The process of claim 17, wherein the time is in a range of 15-30 seconds.

19. The process of claim 7, wherein the liquid composition comprises one or more of a crosslinker, a wetting agent, a viscosity modifier, a defoamer, or any mixture thereof.

20. The composition of claim 19, wherein: the crosslinker comprises poly(ethylene glycol) diacrylate, poly(ethylene glycol) diacrylate, diurethane dimethacrylate, hexanediol diacrylate, trimethylolpropane triacrylate, or any mixture thereof; and/or, the viscosity modifier comprises ethyl cellulose.

21. The process of claim 7, wherein the liquid photoresin composition has a viscosity of about 300 cP or higher and comprises:
a reactive monomer with no hydrogen atoms having a bond-dissociation energy of less than about 410 kJ/mol;
a non-amine reducing agent; and,
a Norrish Type II photo-initiator.
